(19) United States
(12) Patent Application Publication
(10) Pub. No.: US 2007/0168949 A1
(43) Pub. Date: Jul. 19, 2007

(54) System supporting object-oriented constructs in ECMAScript

(76) Inventors: Scott Shattuck, Westminster, CO (US); William J. Edney, Chesterfield, MO (US); James A. Bowery, Las Vegas, NV (US)

Correspondence Address: Mark A. Thomas, 10138 South Cottoncreek Drive, Highlands Ranch, CO, 80130-3848, US

(21) Appl. No.: 11/455,569

(22) Filed: Jun. 19, 2006

Related U.S. Application Data
(63) Continuation of application No. 10/138,631, filed on May 3, 2002, now abandoned.
(60) Provisional application No. 60/288,385, filed on May 3, 2001.

(51) Int. Cl. G06F 9/44

(52) U.S. Cl. 717/115

(57) ABSTRACT

An internally consistent system implementing object-oriented programming constructs in ECMAScript is described. First, a function, rather than the ECMAScript new keyword, is used to initiate new instance creation. The instance creation function is assigned to a non-Function instance rather than an instance of Function as required for use of new. Instances with attached instance creation functions serve as “type proxy” objects and replace the Function instances normally used as types. Since the type proxies and prototype chains created and maintained by the invention are instances of normal objects, rather than instances of Function as required by standard ECMAScript, this approach allows native ECMAScript lookup semantics to be leveraged while supporting inheritance of both state and behavior for instances and types to any level desired. A set of functions known herein as property-definition functions are used by type proxies to assign properties as global, local, instance, or type properties rather than the standard ECMAScript approach of direct assignment. Where constraints exist such as “read-only”, “private”, etc. the physical storage of the property may be located away from the target object in a separate storage structure. Method definitions further place a “backstop” method on Object.prototype. Invocation of the backstop triggers a callback to the non-implementing receiver followed by a scan of guardians for multiple inheritance, followed by dynamic type conversion and method creation. The result is a highly enhanced system of polymorphic behavior.

### CROSS-REFERENCE TO RELATED APPLICATIONS

This application claims priority from and is a continuation of co-pending patent application Ser. No. 10/138,631, entitled “A SYSTEM SUPPORTING OBJECT-ORIENTED CONSTRUCTS IN ECMASCRIPT”, filed May 3, 2002, the disclosure of which is hereby incorporated herein, and further claims priority from provisional patent application Ser. No. 60/288,305, filed May 3, 2001, entitled “A METHOD SUPPORTING ADVANCED OBJECT-ORIENTED PROGRAMMING IN JAVASCRIPT”, inventors, Scott Shattuck, et al., which is hereby incorporated herein.

### REFERENCE TO A MICROFICHE APPENDIX

The source code is referred to in this application is was submitted in patent application Ser. No. 10/138,631 on Microfiche, and is incorporated by reference herein.

### BACKGROUND

1. Field of Invention

A Glossary of Terms

Function:

A process encoded in software which performs some activity and returns a value as a result. Based on the mathematical definition of function.

Procedure:

A process encoded in software which performs some activity but may or may not return any data values. Some programming languages make a distinction between functions and procedures based on whether output is produced.

State:

Information or data. Can be persistent (across multiple invocations of a program) or transient (existing only for the life of a single program).

Behavior:

Capabilities, processes, or functions. A collective noun referring to the combined functionality offered by a particular object.

Object:

A software construct intended to encapsulate state and behavior in a unified form. Traditional software separates functions from the data on which they operate. This separation of behavior (the functions) and state (the data) often led to inconsistent or inaccurate processing of information.

Instance:

A uniquely identifiable individual object.

A single person, single account, single address, etc.

Property:

An individual aspect, element, or characteristic of an object. No particular subdivision between state or behavior is implied.

Attribute:

An individual aspect, element, or characteristic of an object. Typically used to refer only to state-bearing properties of an object.

Method:

A function or procedure that has been bound to a specific instance of an object. Object-oriented languages typically include an automatic mechanism for function and procedure invocation which include passing a reference to a specific instance to the function/procedure thereby “binding” the function to the instance. This reference is accessed with methods via a well-known name, typically “this” or “self”.

Class:

In object-oriented terms, a factory for the construction of individual instances of related items. For example, People, Employees, Department, etc. are classes while you, I, Department 10, etc. are instances. Most object-oriented languages utilize a “new” keyword or function as in “new Department ( )” or “Department.new ( )” to construct instances. As a way of grouping properties conveniently the state and behavioral capabilities of instances are typically associated with the Class.

Type:

A synonym for class in most object-oriented languages.

Prototype:

An object used specifically as a template, often literally “cloned” to create new instances. Each instance so created has (at least in principle) separate memory space for both state and behavioral properties. This differs from Classes in that most class-based languages create an empty memory structure to hold the state of an instance but retain a single shared copy of the behavior/methods. For optimization reasons most prototype-based languages also hold a single shared copy of properties until an operation on the instance would alter the value. At that time the new value is updated on the instance rather than altering the shared value. This process is often referred to as “copy-on-write” since no copy of the properties is made until a “write” rather than a read occurs.

Message:

A specific method invocation request. While a method is a function such as “processPayroll” which can take parameters etc., a message is a specific request to invoke a method. Therefore a message includes information about specific parameter values etc.

Constructor:

A specific form of method used to initialize the memory of newly created instances. In class-based languages instances are typically created with an empty block of memory to hold the state. A two-step process is typically employed in these languages which separate “allocation” from “initialization”. After allocation via the “new” keyword or similar process most languages invoke an initialization function on the newly created instance. This initialization function is referred to as a constructor.

Inheritance:

A term referring to the ability of object Classes or Types to be arranged in hierarchies such that members lower in the hierarchy “inherit” behavior from their parent Classes or Types. A foundational element of the Object-Oriented paradigm. Inheritance is rarely considered complete or true if specialization is not also supported. This refers to the ability of new “subtypes” to alter or “override” the behaviors they inherit from parents.

Encapsulation:

A term referring to the goal of hiding from external parties “how” a particular behavior is accomplished. By hiding implementation details programs are made more modular and less likely to have errors. A second core tenet of Object-Oriented programming. A specific example would be calculation of age. Two mechanisms are possible from a state perspective. First, an instance might store the actual age as in 42. Second, the instance might store the birth date and perform a calculation relative to the current date to derive age when queried. Encapsulation implies that requestors are provided simply with a “getAge” method interface. The details of how age is calculated are “encapsulated” with the object and not made public, thereby avoiding unnecessary dependence on specific implementation details.

Polymorphism:

A specific term referring to the ability of objects of different Classes or Types to respond via different methods to the same message. Using our “getAge” example from the encapsulation discussion instances of people might store a birthday and compute on the fly while instance of wine might hold a number of years. Often associated with inheritance since specialization through overriding of parent behavior is a clear example of polymorphism. However, polymorphism does not strictly require an inheritance relationship to exist between the types being considered.

This invention relates to programming in ECMAScript, commonly known as JavaScript™; specifically to a system supporting advanced object-oriented programming in ECMAScript and its derivatives.

2. Description of Prior Art

With software increasing in complexity the programming industry has turned to a variety of approaches to improve quality and reduce development time. Object-oriented programming languages are one of the premier technologies used to assist developers in producing quality applications in less time.

Object-oriented technology is based on three core principles: inheritance, encapsulation, and polymorphism. In addition, a number of object-oriented development patterns require type and instance introspection, also known as “reflection”. These features are prominent in the Smalltalk language which pioneered the OO paradigm. They have also found their way to varying degrees into other object-oriented languages such as C++ and Java. Java, in particular, gains much of its power and popularity from supporting these fundamental object-oriented features.

ECMAScript and its derivatives have extremely limited support for these features, severely curtailing their use as application development languages. Due to ECMAScript's prominence in programming for the World-Wide-Web the lack of these features in ECMAScript severely limits web development as well.

Inheritance

Inheritance is a fundamental feature of object-oriented programming languages. Through inheritance programmers are able to reuse existing functionality, decreasing both code size and the number of bugs.

With respect to inheritance, ECMAScript, and this invention, and java object-oriented programming languages fall into two categories: class-based and prototype-based.

In class-based languages such as Smalltalk, C++, and Java constructs known as classes are used as factories or templates from which individual instances of the class are constructed. In such languages the creation of new instances therefore first requires a class to be defined. Defining a class requires the specification of a parent class or “superclass” from which the newly defined “subclass” will inherit. The root class, the top of the inheritance hierarchy, is typically “Object”. Object provides a common subset of behavior that all instances can be assured of. Each subclass definition must also include specification of any new state (i.e. attributes, or data) as well as any new behavior, (i.e. functions or methods) which instances of the subclass will share. Depending on the language, state and behavior for the subclass object itself may also be defined.

In a class-based language when a new instance is created memory is allocated to store the unique state variables of the instance. In addition, a reference to the class which created the instance is also assigned to the instance to support traversal of the class hierarchy during inheritance lookups.

Once memory has been allocated and the class reference structures are in place the instance is initialized via a function or method known as a constructor. The constructor is responsible for setting any initial state and performing whatever other instance-initialization may be required to ready the instance for use. As an example, in Java the syntax for creating a new instance is:

newInstance=new ClassName(parameter1, parameter2, . . . );

In the previous example, the new keyword serves as the instance-creation mechanism while the ClassName( ) function serves as the constructor. When the instance has been allocated and assigned its class reference the constructor function is automatically invoked to complete the initialization process. This pattern of an instance-creation operation which subsequently invokes an instance-initialization method or constructor function is common in class-based languages.

While each instance, by virtue of having its own memory allocation, owns its state variables, in a class-based language instance behavior is reused by storing it with the instance's class. Behavior for each instance is found by traversing the instance's class reference. The search continues from the instance's class to that class's parent class and so on until the top of the inheritance chain is reached or the requested method is found. The search typically ends with the Object class. Note that since instances do not store their own behavior they share the behavior defined via their class.

Unlike class-based languages, prototype-based languages like Self are composed entirely of instances which act as “prototypes” from which other instances acquire both state and behavior. A pure prototype language does not require classes for the creation of new instances nor does it use them when looking up state or behavior. In pure prototype-based languages the mechanism for creating a new object is to duplicate or “clone” an existing object and modify it as needed. This action is atomic (single-step) without the two step creation-initialization process of class-based languages. Each instance created via cloning retains a reference to the prototype which was cloned. This prototype reference is followed whenever state or behavior are not found on the instance. If the state or behavior are not found on the instance's prototype the prototype's prototype is searched and so on until the end of the “prototype chain” is reached.

Because certain instances are used repeatedly as templates they do tend to take on a special role and are often referred to as types. The distinction between these types and classes however is that these types are simply instances with well-known public names.

Unlike class-based languages in which instances can only be modified with respect to their state, prototype-based languages support direct customizing of the behavior of each instance. Given that there are no classes on which to define behavior in these languages the only way to customize instance behavior is to either alter the behavior of the instances themselves or alter the prototypes from which they inherit. In any case, since everything is an instance everything can be modified.

An additional difference between class-based and prototype-based languages relates to memory usage. To maximize reuse of state and behavior while minimizing memory requirements, prototype-based languages often employ what are known as copy-on-write semantics. When copy-on-write semantics are employed a new instance does not automatically have memory for each of its properties (variables and functions combined) allocated. Instead, properties which are never altered are looked up via the prototype chain. Unlike most class-based languages where lookups are performed only when searching for behavior, most prototype-based languages perform lookups for both state and behavior. New memory is only allocated when a write operation requires the instance to store its own unique values for the modified property. The result is that prototype-based languages tend to be very efficient with respect to their memory usage.

ECMAScript as of the ECMA-262 Edition 2 standard is essentially a prototype-based language.

Originally designed to support interactive behavior for HTML web pages, ECMAScript was designed to be easy to program as well as efficient. To accomplish these goals ECMAScript was based heavily on prototype-based language principles. Each instance in ECMAScript can be modified locally and copy-on-write semantics are used to keep memory overhead to a minimum (very important considering the target of running in a web browser). In ECMAScript a number of well-known type objects do exist but as with other prototype-based languages these types are themselves simple object instances.

There is one major difference between ECMAScript and a pure prototype-based language however, and that difference is the source of a significant problem with respect to inheritance.

Unlike other prototype-based languages which rely on cloning existing instances to create new ones, ECMAScript uses a two-step instance-creation/instance-initialization approach similar to class-based languages. Creating a new instance in ECMAScript requires use of the “new” keyword and a constructor function to be used as in:

newInstance=new ClassName(parameter1, parameter2, . . . );

Note that the syntax used above is identical to that used in the previous Java example to create a new instance. The aspect which makes ECMAScript differ from Java is that in the previous example the type, ClassName, is simply an instance of Function created via:

// create a new “type”

ClassName=new Function( ){ };

In Java the class ClassName would not be an instance with the ability to be modified with new state and behavior. ECMAScript's types retain this capability for local modification but they do so at the expense of a clean mechanism for supporting inheritance lookups.

Unfortunately, because the new keyword and constructors are used rather than simply cloning instances a normal prototype chain for lookups of state and behavior won't work. If all instances were to reference their constructor functions as their prototypes and those constructor functions then pointed to their constructor functions as prototypes the resulting inheritance hierarchy would always consist of:
the object itself
the object's constructor
Function (since all constructors, being functions, would point to their constructor . . . Function)

Clearly it would be inadequate for an object-oriented language to be so limited with respect to inheritance so to avoid this problem ECMAScript uses a unique variation. In addition to being valid targets for the new keyword, each ECMAScript type object is automatically assigned a unique prototype instance which is used when looking up state or behavior.

When ECMAScript attempts to find state or behavior on an object it looks in the following places:
the object itself
the object constructor's prototype
the object constructor's prototype's constructor's prototype
the object constructor's prototype's constructor's prototype's constructor's prototype

The search continues using this constructor.prototype pattern until it reaches the top of the prototype lookup chain. In ECMAScript, the top of that chain ends at Object.prototype.

Since each individual prototype object can be constructed using any constructor ECMAScript's use of the constructor.prototype link allows ECMAScript instances to inherit state and behavior from a hierarchy containing an unlimited number of levels. Unfortunately, as closer inspection will reveal the same is not true for the types themselves.

Since all types in ECMAScript must be instances of Function all types clearly inherit by searching the type itself followed immediately by Function.prototype. As it turns out, the instance referenced by Function.prototype is, for all intents and purposes, created via new Object( ); so the chain stops at Object.prototype. This means ECMAScript types inherit along a very shallow hierarchy consisting of:
the type itself
Function.prototype
Object.prototype

Simply put, ECMAScript type objects cannot inherit state or behavior from other type objects. If I have a type Car which is a type of Automobile which is a type of WheeledVehicle which is a type of Vehicle which is a type of Object it is impossible using standard ECMAScript inheritance mechanisms to have state or behavior inherited by the Car type object which is defined on the Vehicle type object. Both the Car and Vehicle objects—as instances of Function—will search themselves, then Function.prototype, then Object.prototype. This effectively cripples ECMAScript as an object-oriented language.

The fundamental guarantee of object-oriented programming has been stated as:

If class Y is a descendant of X, then code that executes without method resolution failure on instances of X should also execute without method resolution failure on instances of Y.

A simpler way of putting it is that for an object-oriented language to work it must always be true that instances of a subclass can function effectively as instances of their superclass. This should be obvious since as instances of a subclass they inherit all the state and behavior of an instance of their superclass.

Unfortunately, ECMAScript fails to meet this fundamental guarantee as a simple example will show.

It is common in object-oriented programming to have methods on instances rely on methods defined on their class as part of their implementation. For example, if an instance method needs to access the name of the class to which it belongs it would typically locate that information using a call similar to:

className=this.getClass( ).getClassName( );

Unfortunately, since ECMAScript doesn't support type inheritance given any instance method defined for instances of type X which invokes a type method we will experience method resolution failure should that instance method be invoked on an instance of Y. Since type Y cannot inherit type state or behavior from other types including type X any method defined on X for instances of X which relies on the instance's type to perform a function will fail to locate that function when invoked from an instance of Y.

If instances of Y cannot be used interchangeably as instances of X it seems clear that ECMAScript cannot currently be used to do robust object-oriented programming since it fails to support the fundamental guarantee of object-oriented programming, namely: that instances of a type should function without failure as instances of their supertypes.

Because individual instances including types can be manipulated with respect to both their state and their behavior one method which has been used in an attempt to avoid this problem is to simply copy all state variables and functions from each supertype to any and all subtypes. In other words, although each type object directly inherits from Function.prototype each type is also an instance which can have state and behavior copied directly onto the type itself. This approach, referred to here as “copy-down” inheritance, has several disadvantages.

First, copy-down inheritance significantly increases memory requirements since each subtype now requires space to hold references to each state variable and function. Second, copy-down eliminates the dynamic lookup behavior of ECMAScript. In the case of normal ECMAScript lookups if, after subtype creation, a method or state on the supertype were changed it would be immediately visible to subtypes. When copy-down semantics are employed it becomes necessary to propagate any change in a supertype down to any and all subtypes which don't have unique implementations. Doing this successfully requires checking each subtype to determine if it already contains a property with that name and if so whether it is unique with respect to the new method being copied down. This must be done to avoid copying over something that has been already modified in the target instance. As it turns out making this distinction in ECMAScript because of the inherent lookup mechanisms and lack of reflection capability is extremely difficult and imposes significant performance overhead. Third, because type instances share a common prototype (Function.prototype), name space collisions must be handled by ensuring each property name is unique when the copy is performed. As with the rest of the copy-down scheme, this requirement adds significant overhead to the process. In essence, copy-down eliminates all of the benefits inherent in the copy-on-write approach ECMAScript naturally uses in an attempt to provide limited support for some form of type inheritance. Given ECMAScript's type hierarchy problem it should be clear that a ECMAScript programmer also can't get accurate type hierarchy information from the type without storing it themselves. Normally, when attempting to determine the type of an instance it is possible to use the instance's constructor reference which points to the actual Function instance which created the instance. Using this reference it is then possible to extract the name of the function which is essentially the name of the type. Unfortunately, this won't work for types themselves.

Since each ECMAScript type is an instance of Function all types respond to this line of questioning by stating they are Functions. The resulting hierarchy is only two levels deep with Function at the top and every other type sharing the level below. Again, a fundamental element of object-oriented programming, reflection on the nature of the inheritance hierarchy, is difficult to support in native ECMAScript.

While a few attempts have been made to improve ECMAScript's ability to support a Java-style system of classes and methods, none have addressed the fundamental limitations of type inheritance which are central to ECMAScript's failure to support the fundamental guarantee of object-oriented programming.

An additional problem with respect to inheritance in ECMAScript is the lack of a mechanism for invoking inherited implementations of functions properly. This severely limits use of ECMAScript in an object-oriented fashion since it means subtypes can't override yet still invoke supertype implementations.

Assume a type A which provides instances with a method “print”. In standard ECMAScript this means A.prototype has a print function assigned to it. Further assume type B inherits from type A and that type C inherits from type B. To ensure that inheritance functions properly the developer uses A to construct B.prototype and B to construct C.prototype. This ensures that lookups originating on an instance “c” of type C will follow the chain from c to C.prototype, to B.prototype, to A.prototype where the print function will be found.

But what if instances of C need to “override” the default implementation and extend it or otherwise specialize it? In that case the developer would place a “print” function on C.prototype so that all instances of C could invoke it. Unfortunately, if the implementation of print assigned to C.prototype needs to invoke the original version on A.prototype there is no mechanism in ECMAScript that will support this.

Languages like Smalltalk, C++, and Java all support a mechanism collectively referred to as “call super”. This idiom refers to the many times when a subtype needs to override but still invoke a supertype method implementation. ECMAScript has no support for this critical element. Attempting to create a simplistic solution by simply calling A.prototype.print( ) within C.prototype.print will not work. Here's why.

When a function is invoked in ECMAScript via an object reference as in C.prototype.print( ) the object immediately before the function name is passed to the function as the value of the special variable “this”. It is this “binding” of the object to the “this” reference that allows ECMAScript functions to behave like “methods”. In our print method example the print method itself needs to reference the data of the object in question so that the proper instance data is printed. It does so via the “this” reference.

As one can see, attempting to call A.prototype.print( ) inside C.prototype.print won't work because the ultimate instance being messaged is “c” and “c” won't be bound to “this” when the A.prototype.print( ) call is made. What will be bound is A.prototype. So the values of A.prototype will print rather than the values in “c”. This situation is further complicated by the fact that every instance can contain its own specific print method so proper lookup of the method to invoke (or chain of methods if both B and C have overrides) becomes extremely complex. In short, ECMAScript has no support for this fundamental object-oriented development technique.

Recently the recognition of ECMAScript's failings to support robust object-oriented semantics has led to work on a new ECMA-262 Version 4 specification which would address some of these needs. The new Version 4 specification calls for the addition of a class keyword as well as a number of other alterations to the ECMAScript language which would attempt to repair ECMAScript's type inheritance problems.

The main disadvantage of this approach is that it turns its back on ECMAScript's history as a prototype-based language in favor of redesigning ECMAScript into a class-based language. Many of the dynamic features of the current language implementation will be lost. The result is a significant alteration to the existing language which is not backward compatible with the versions currently implemented and deployed in major web browsers and products. Programs written to rely on existing Version 3 semantics will not function properly in the new Version 4 language but instead will have to be rewritten if they are to take advantage of Version 4 features.

Moreover, existing web browsers will have to be upgraded to support the new language before programs which require the new language semantics could be widely deployed. The result for the web development industry could be significant as an estimated 3 million web pages were using ECMAScript in its current form as of January 2000.

Encapsulation

ECMAScript properties (object attributes and methods) don't require type definitions as in other “strongly typed” languages such as Java. In other words, to create an object property in ECMAScript the approach used is to directly assign a value to a target object property as in:

myObject.property = ’abc’;
myObject.property = new Date( );
myObject.property = new Object( );
myObject.property = function ( ) { return this.otherproperty; };

Note that in each of the previous examples no pre-declaration of the myObject.property slot or specification of which data type will be placed in the myObject.property slot is required. Also note that the same slot is used to store values of various types without issue. Since no syntax is used to declare or define object properties, ECMAScript as of ECMA-262 Version 3 does not support visibility or mutability constraints such as declaring a property to be public, private, protected, final, or const as you might find in Java or similar object-oriented languages. (Officially the var keyword should be used to avoid problems with namespace collisions but no type information is used in a var declaration).

All ECMAScript properties are publicly readable and writable and all methods can be executed by all requestors regardless of the calling context. The effect of this behavior is that ECMAScript does not support “encapsulation” in the object-oriented sense.

In a language supporting encapsulation—such as Smalltalk—the specific nature of an object's state variables and private methods is hidden behind a public interface and protected from direct read/write or execution operations. Encapsulation of state and behavior is one of three primary indicators of whether a language is truly object-oriented—the others being inheritance and polymorphism. Unfortunately, since all ECMAScript properties are publicly readable/writable/executable the language does not natively support this critical object-oriented feature.

In all available documentation and texts written on the subject of ECMAScript the assignment of properties—attributes or methods—is always performed via direct assignment. The limitations of using direct assignment for property definition are many.

First, ECMAScript's direct assignment model does not provide an opportunity to define mutability constraints. With direct assignment it is not possible to control whether a property is “final” or “const”. The final declaration (or “sealed” to use Dylan terminology) applies to methods or attributes which should not be capable of being overridden or otherwise redefined in subclasses. In a language such as Java or Dylan which support such concepts it is an error to provide a new definition of a method or attribute declared as final or sealed. A const declaration applies to attributes whose values should not be writable. This is essentially the same as “read-only”. Once the initial value for a const variable has been set no changes to the value are allowed. Again, because of ECMAScript's lack of support for encapsulation read-only properties are not supported.

The concept of read-only properties is a consistent requirement of robust application development however. For example, in an application managing employee data several individuals may have the ability to read a particular property but only the employee and the employee's manager may have the ability to write a new value for the property. Read-only data is a common programming requirement which is unsupportable using ECMAScript's direct assignment approach.

Second, direct assignment does not provide an opportunity for defining visibility constraints. In object-oriented languages such as Java, Objective-C, and C++ properties can be declared public, private, protected, or in similar ways constrained with respect to the context in which they are exposed. In the generally accepted definition of these terms, private properties should only be visible from within the object itself, protected properties should only be visible from within the object or an object that is a subtype of the type of the object, and public properties should be visible from anywhere. Java also introduced the concept of “package” visibility which allowed properties to be visible to other objects loaded from the same software package or module.

In ECMAScript every property is public. No constraints exist on either viewing or manipulating ECMAScript properties. This creates opportunities for programmers to rely on private or protected properties which are specific to a particular implementation of functionality. If the details of the implementation needs to change—even though the public interface for the object remains constant—the program relying on these private implementation details will fail. The ability for programmers to write code dependent on specific implementation details rather than public interfaces—and the fragility it creates for programs—is precisely why encapsulation was perceived as one of the primary advantages of using an object-oriented language.

Third, direct assignment doesn't provide accurate information for introspection or reflection. Using native ECMAScript it isn't possible to differentiate between instance variables whose contents coincidentally contain function references and true methods which make up the behavioral interface of the object. In object-oriented terms a method is a function which is bound tightly to an object and which provides behavior for that object. Since functions in ECMAScript are themselves objects and are capable of being passed as parameters or assigned to variables the potential for confusion regarding the actual public interface of an object is large. It isn't possible in ECMAScript to determine whether the assignment:

myObject.dateFunc=function( ) {return new Date( );};

defines a method on the object or simply a function which can be acquired from the object by accessing the dateFunc property.

When programming certain applications the ability to reflect on the behavioral interfaces of the objects in the system becomes critical. This reflection capability was a major addition to later versions of the Java language which allowed the Java Beans and Enterprise Java Beans programming paradigms to exist. Without accurate reflection on object methods neither of these technologies would be available today. ECMAScript's inability to accurately reflect on object behavior is a serious flaw which limits the power of programs written in the language.

Fourth, direct assignment doesn't provide an opportunity to manage data for a set of instances in a coherent fashion. Encapsulating instance data behind a functional interface means you can move or otherwise restructure the data without affecting the public behavior. By managing the data away from the instances themselves advanced data manipulation and data management can be performed. Direct assignment's failure to provide encapsulation means such group management of data outside the confines of the instances themselves is not possible. In the case of ECMAScript this has serious performance implications.

Fifth, direct assignment doesn't provide the ability to control method access i.e. execution. As with attributes, methods can be declared public, private, or protected. Failure to support encapsulation means there is no mechanism for stopping inappropriate method execution. Furthermore, by assigning methods directly to target objects a valuable opportunity is lost. As the invention shows, the use of a property-definition function which supports encapsulation of methods is not only required for visibility constraint enforcement it enables certain mechanisms which are useful for debugging running programs, logging execution statistics, and other tasks.

Sixth, a subtle bug can creep into ECMAScript programs with respect to direct assignment. When ECMAScript performs direct assignment it uses copy-on-write semantics. This implies that if the property in question were inherited from an instance's constructor's prototype the instance being messaged would receive a new property rather than altering the property on the constructor's prototype. An example makes this clear.

Assume the property in question is an array. If I reassign the array entirely everything is fine. In other words, this works:

// define a test type with an array property for instances to inherit
MyObject = function ( ) { };
MyObject.prototype.anArray = [1,2,3];
// define first instance
myObjectOne = new MyObject( );
// define second instance
myObjectTwo = new MyObject( );
// update first instance by assigning a new array
myObjectOne.anArray = [4,5,6];

At the end of this operation the two instance no longer share the array containing [1,2,3]. The first instance, myObjectOne, now has a “local” array reference pointing to the array [4,5,6]. The second instance still inherits the array [1,2,3] from its constructor's prototype.

The bug comes in if we modify the array rather than completely reassigning it. In this case, although technically a write is occurring, no copy will be made. Again, an example will make this clear:

// define a test type with an array property for instances to inherit
MyObject = function ( ) { };
MyObject.prototype.anArray = [1,2,3];
// define first instance
myObjectOne = new MyObject( );
// define second instance
myObjectTwo = new MyObject( );
// update first instance by assigning a new array
myObjectOne.anArray[myObjectOne.anArray.length] = 4;

Now something different has occurred. While I might have expected that the variable anArray which I believed to be an instance variable would have been copied and updated to contain [1,2,3,4] that's not what happens. Instead, the array on MyObject.prototype is modified in place. At the end of this operation both instances, myObjectOne and myObjectTwo, see an array containing [1,2,3,4]. What happened? ECMAScript doesn't use copy-on-write for reference types. In particular, any modification of an Array or Object in this fashion will not create a new copy.

Polymorphism

Polymorphism as defined in object-oriented terms is the ability of different types in the system to respond to a message with type-specific methods. In object-oriented terms the message refers to the request while the method is the implementation. For example, a text document and an image may be printed. Assuming a system that used the ‘print’ message to request printing activity the document and image would both be messaged to ‘print’. However, in polymorphic systems the functions the document and image invoke in response to the print message can differ based on their type. Experienced object-oriented programmers rely on polymorphism to send messages to objects directly, allowing them to respond in an appropriate type-specific fashion, rather than performing preliminary type checks or other type-specific processing. Reliance on polymorphism can lead to errors in ECMAScript however.

ECMAScript supports polymorphism through its standard lookup mechanisms. Using the prototype chains described earlier, when a message is sent the actual implementing function is looked up via the prototype chain. Unfortunately, since ECMAScript is a loosely typed language there is no guarantee that a function will be found. When a ECMAScript program incorrectly messages an object which can't respond an error occurs which often terminates processing of the ECMAScript program.

In Java and other strongly-typed languages it is not possible for the programmer to invoke methods on objects which cannot respond properly to them. Languages such as Smalltalk which have method lookup processes similar to ECMAScript's have addressed the polymorphism problem by providing a “catchall” method which is invoked when a method lookup fails. This catchall method can be managed by the programmer such that the error can be handled. In the prior art the common catchall method (doesNotUnderstand( )) opens a debugger.

When an end user is confronted with either a program termination due to a missing method implementation or a debugger the program has essentially crashed. This is an inadequate solution. ECMAScript programmers should be able to rely on polymorphism without fear of program crashes due to missing method implementations.

No known attempts to resolve this situation have been made for ECMAScript.

Reflection

Reflection refers to the ability of a programmer to query a type or instance for information on its properties, including items such as attributes, methods, supertypes, subtypes, etc. In languages such as Java this capability is used extensively to support what are known as Java Beans, a core functional component of the Java Enterprise solutions offered by Sun. Without reflection however, Java Beans would be impossible to implement.

ECMAScript unfortunately doesn't have built-in mechanisms for performing accurate reflection. While it is possible to iterate on an instance properties via the “for/in” construct of the language it isn't possible to determine which properties are functions and which are methods. Remembering that in ECMAScript a function is bound to an object at execution/call time there is no way to separate attributes holding functions from true methods. Since ECMAScript functions are capable of being assigned to any variable and/or passed as parameters there are no distinguishing features of a “method” as opposed to a simple function. This implies that an object can't tell you what its actual attributes or methods are since it can't distinguish between the two.

A second complication is that ECMAScript can't properly distinguish between methods that are implemented “locally” (only on the instance itself), at the “instance” level (on the instance's constructor's prototype), or somewhere up the inheritance hierarchy.

The lack of coherent reflection severely restricts programming using Bean-like patterns in native ECMAScript.

### SUMMARY

Inheritance

The invention defines a specific new arrangement of ECMAScript data structures, objects, and functions such that inheritance of state and behavior for objects acting as types can be maintained to any desired depth. The invention therefore allows ECMAScript implementations to fulfill the fundamental guarantee of object-oriented programming: namely, that instances of subtypes should function without failure as instances of their supertypes. The invention accomplishes this goal while retaining all of the dynamic inheritance and copy-on-write semantics provided by the native ECMAScript language. Because multi-level type inheritance is made possible by the invention, accurate type inheritance information can be maintained to ensure type reflection is supported. Further, proper method lookup and method override processes are supported such that inheritance hierarchies are valid mechanisms for specialization and extension.

The fundamental design concept underlying the invention is the construction of what is known in prior art as a meta-object system. This type of system has never been implemented within ECMAScript prior to the invention. In addition, no references could be found on implementations of meta-object systems that were not built as part of the initial construction of the language itself. Smalltalk, Self, Lisp and others have meta-object systems but those systems were constructed as part of the initial language design. The invention adds a meta-object system to ECMAScript, a language with no inherent meta-object structures.

Meta-object systems make use of a complex system of “meta types” which form a top-level inheritance hierarchy from which individual type objects themselves inherit. In essence, types become instances . . . instances of a “meta-type”. A critical innovation is that by implementing a system in which types are instances the invention leverages native lookup semantics for instances—which ECMAScript properly handles. The result is a unified class/prototype language which is able to support full type inheritance and thereby support the fundamental guarantee of object-oriented languages without requiring existing browsers to be upgraded or existing ECMAScript pages to be reworked to support a new language standard.

Objects and Advantages

Accordingly, several objects and advantages of the invention with respect to inheritance are:
to allow ECMAScript programmers to write robust object-oriented programs which can depend on adherence to the fundamental guarantee of object-oriented programming: namely that instances of subtypes should function without failure as instances of their supertypes
the native ECMAScript lookup mechanism via the constructor.prototype chain remains in effect thereby optimizing performance of the lookup process.
no changes are required to the current implementation of ECMAScript as currently defined and implemented in web browsers and other ECMAScript environments.
no plug-ins or other modifications are required to client web browsers or other ECMAScript environments to take advantage of these features.
the size and memory requirements of a running program are optimized by providing support for reuse of both instance and type related state and behavior.
common object-oriented design patterns which rely on proper type-inheritance semantics may now be implemented in ECMAScript without fear of lookup failures or other type-inheritance related problems
no specialized knowledge is required for current ECMAScript programmers to take advantage of these features.

Other objects and advantages of the invention with respect to inheritance are:
the state of a supertype object can be inherited by all subtype objects without copy-down semantics thereby retaining dynamic inheritance of state changes
the behavior of a supertype object can be inherited by all subtype objects without copy-down semantics thereby retaining dynamic inheritance of behavior changes
instance methods which rely on type state or behavior can function without lookup failures regardless of which subtype's instance invokes them
supertype methods and state can be accessed as part of any new methods defined in subtypes designed to augment their supertype's implementation or state
a subtype can override a supertype method or state variable defined at any level and still refer to the supertype implementation as part of the subtype implementation
copy-down semantics can be intelligently combined with the invention's inheritance mechanism to provide multiple inheritance capability
types can still be specialized with local methods and state thereby allowing them to have type-specific behavior and data.
the inheritance hierarchy can be dynamically manipulated or altered at runtime for both instances and types themselves
the instance-creation process can be modified through both inheritance and instance-level programming such that each type can inherit instance-creation logic from its supertypes and customize that behavior as needed.
the instance-initialization process can be modified through both inheritance and instance-level programming such that each type can inherit instance-initialization logic from its supertypes and customize that behavior as needed.
manipulation and modification of the operation of the invention's functions and data structures can be performed by the programmer since the invention is itself implemented in native ECMAScript.
alterations in supertypes can be automatically reflected in dependent types, even when copy-down inheritance techniques have been utilized.
   Encapsulation

The invention includes a new coordinated set of ECMAScript data structures, objects, and functions for property-definition, property-reflection, and property-access. When a new property is defined supertype constraints for the property are checked. Information related to the property definition is then captured in reflection entries managed by the type. These reflection entries are checked by the property-definition functions themselves to ensure any property constraints imposed at the supertype level are met. The reflection entries also support property-reflection methods which allow developers to query the type for information on the various type properties.

To ensure the constraints imposed during property definition are maintained, the property-definition functions optionally initiate generation of appropriate data storage for each property which will protect the property from inappropriate access. The property-definition functions also generate appropriate property-access methods based on the constraints defined for visibility and mutability. Property-access methods generated by the system can be further controlled to provide a variety of debugging and profiling data based on system configuration parameters.

Objects and Advantages

Accordingly, several objects and advantages of the invention with respect to encapsulation are:
support for object encapsulation by controlling property creation and access
support for accurate reflection on object attributes and methods
support for tracing and profiling method invocations and attribute accesses
support for advanced data management functionality for sets of instances

Other objects and advantages of the invention with respect to encapsulation are:
properties defined for an object can be checked against supertype constraints such as “final” prior to completing the definition of the property in the subtype.
properties defined for an object can be declared to be of a certain type which can be checked by generated access methods such that assignment of a value to that property which doesn't meet the specified type constraint would result in an error.
properties can be given default values which can be returned by generated access methods when no storage has actually been allocated for the property in question.
properties added to each object or type can be tracked by reflection data structures such that later inquiries about object state can be answered quickly and correctly.
properties can be declared as public, private, protected, or in similar ways constrained with respect to their visibility and access from other objects in the system.
properties can be declared final such that redefinition of the method or attributes in a subtype would cause an error
properties can be declared const such that attempting to set a new value for the property after the initial value has been assigned would result in an error
property access methods can be wrapped by predefined control methods which track invocation time, invocation parameters, the calling context, and other environmental data which can be used for debugging and profiling of the application.
property storage can be separated from instances to ensure mutability, visibility, and access constraints are met by hiding the data from casual exploration of the object.
property storage can be separated from the individual objects to provide better control over data manipulation operations which must work across multiple instances.
property storage can be separated from the individual objects allowing instance data loaded from a server to remain separate from the instances themselves eliminating the need for reconstitution of the data into object form as it is received from the server.
property storage can be separated from the individual objects allowing high performance searching, sorting, or other instance data manipulations to occur
with separate data storage, fast indexing of instance data becomes possible such that sets of instance data can be queried for subsets matching particular criteria.
with controlled access copy-on-write for attributes which are reference types can still be maintained avoiding subtle bugs.
   Polymorphism

The invention includes a specific new arrangement of ECMAScript data structures, objects, and functions which ensure method failure does not occur without a “catchall” hook being invoked. Further, this catchall hook has been significantly changed beyond the implementations of previous languages such as Smalltalk. Support is included for automatic type conversion and method construction to dynamically generate missing methods, thereby significantly increasing polymorphism while reducing developer effort and user-visible errors.

Objects and Advantages

Accordingly, several objects and advantages of the invention are:
trapping of previously uncaught “not found” exceptions, reducing program instability
increased polymorphism by leveraging automatic type conversions to respond to missing methods
increased library functionality through the combinatoric effects of type conversions and method generations.
decreased library size by leveraging client-side method generation to replace static code

Other objects and advantages of the invention with respect to polymorphism are:
inferred type conversions and method generations can be logged for developer review
inference logs can be used to direct optimization efforts with respect to type conversions and methods
system development time is reduced by simply increasing the number of potential type conversions. Automatic type conversions will increase, creating a parallel increase in functionality with minimal effort.
   Reflection

The invention includes a specific new arrangement of ECMAScript data structures, objects, and functions which cooperate to support type and instance reflection. This allows programmers to query both types and instances regarding their supertypes, subtypes, attributes, and methods. With this information programming patterns such as those popularized by Java Beans can be implemented using the invention. The resulting flexibility for web programmers is critical if applications of any size and complexity are to be developed.

The invention makes reflection information available not only to the developer but to the internals of the system itself in support of both inheritance and polymorphism as defined earlier. An important feature of Java, modeled on the “protocols” of Objective-C is “interfaces”. An interface is essentially a list or collection of messages that an object may “conform to”. Conformance means that the object implements methods for each message in the interface or protocol. In dynamic languages the use of protocols or interfaces is an important way of ensuring that objects aren't sent messages they can't respond to—a feature known as “type safety”. With no compiler to check this at runtime, dynamic languages which are able to rely on reflection to check receiving objects for methods. The invention's support for accurate runtime reflection ensures that interface support, and therefore type safety, are supportable.

Objects and Advantages

Accordingly, several objects and advantages of the invention with respect to reflection are:
to ensure accurate inheritance information regarding subtypes and supertypes is maintained such that programmers using the invention may reflect upon, and receive accurate information regarding, the inheritance hierarchies they create.
Information on the attributes and methods of types and instances can be acquired, allowing developers to verify conformance to interfaces or protocols at runtime.
Bean-like programming patterns and paradigms can be implemented, supporting an easier learning curve for developers transitioning from Java to ECMAScript.

Other objects and advantages of the invention with respect to reflection are:
reflection information describing the type hierarchy is accurately maintained at runtime including information on subtypes, supertypes, and the types of various instances such that dynamic alterations are possible without sacrificing accuracy
reflection information on instances which have been created can be maintained including maintaining collections of all instances created of a particular type.

Further objects and advantages of the invention will become apparent from a consideration of the drawings and ensuing descriptions.

### DESCRIPTION OF DRAWINGS

FIG. 1 documents the unique objects, functions, and relationships which are created and managed to provide the inheritance functionality supported by the invention.

FIG. 2-A displays a flow chart defining the process used by the attribute definition functions in processing their incoming attributes, defining property storage, and generating access methods.

FIG. 2-B displays a flow chart defining the process used by the method definition functions in processing their incoming functions, defining function storage, and generating access methods.

FIG. 3-A displays a flow chart defining the process used by the call-stack management function to keep an accurate set of calling context information.

FIG. 3-B displays a flow chart defining the process used by the visibility constraint function to determine whether the current calling context violates a visibility constraint.

FIG. 4 displays a flow chart defining the process used by the polymorphism catchall or “backstop” mechanism to support error trapping, type conversion, method generation, and runtime execution optimization

### DESCRIPTION OF INVENTION

Inheritance

The invention makes use of ECMAScript's existing innate lookup machinery coupled with the addition of two reference components or targets to get inheritance information and thus, overcome the disadvantages of ECMAScript.

The method creates a proxy type reference along with instance references for the lookup machinery to access. By creation of a dictionary of type and instance data with their supertypes and subtypes the lookup machinery is able to find the correct resources to use. The addSubtype function knows where to look for type constructors. The create function knows where to look for instance constructors. The method thus searches for attributes of both types and instances within the proper innate lookup hierarchy.

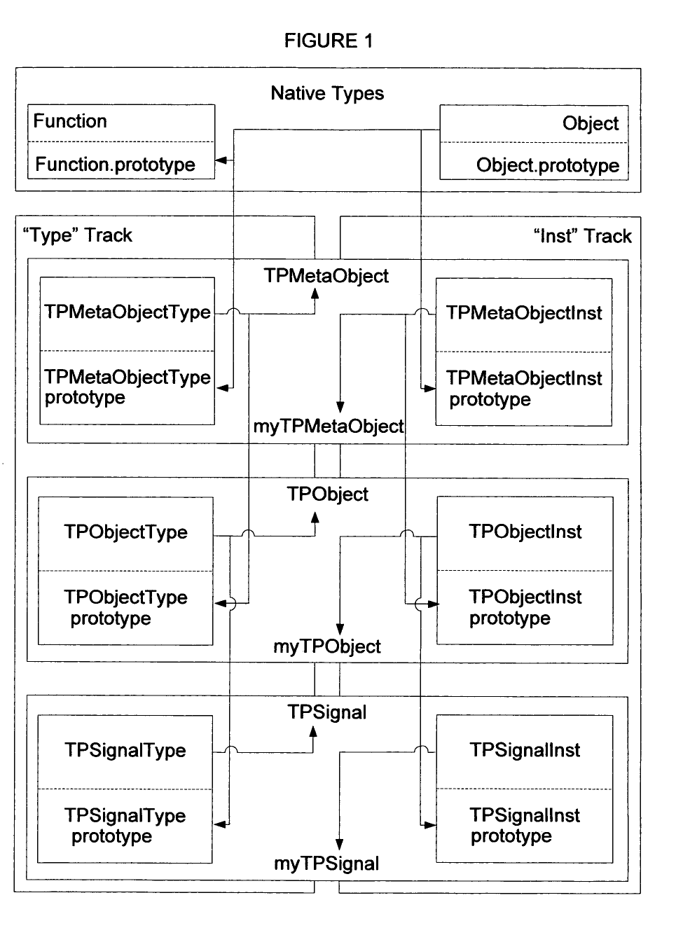

FIG. 1 defines the specific arrangement of objects and functions which implement the inheritance functionality provided by the invention.

At the top of FIG. 1, in a box labeled “Native Types”, are the ECMAScript Object and Function types along with their prototype instances. The box itself is diagrammatic and does not comprise a real data structure or element of the system. The Object and Function types are not part of the invention, however, they form the top level of the inheritance hierarchy which the invention's meta-object system ultimately leverages.

Directly below the Native Types box in FIG. 1 are two parallel vertical boxes or “Tracks”. On the left-hand side of FIG. 1, the box labeled “Type Track” contains the elements responsible for managing type inheritance. On the right-hand side of FIG. 1, the box labeled “Instance Track” contains the elements responsible for managing instance inheritance. As with the Native Types box, these Track boxes are diagrammatic and do not themselves define a real data structure or other element of the invention.

Each of the two Track boxes, which run vertically through FIG. 1, is segmented into three horizontal Type Layers. These Type Layers are shown joining the two vertically-oriented tracks horizontally such that each Type Layer individually encloses the components used to support the functionality of a single type. In FIG. 1 the types so described and enclosed are named TPMetaObject, TPObject, and TPSignal.

TP is a convention to designate Technical Pursuit's addition to the ECMAScript and OOP lexicon. The prefix “my” in lower case is a convention for instance.

Note that in FIG. 1 the inheritance structure being described is one in which Object is the supertype of TPMetaObject which itself is defined as the supertype of TPObject which is the supertype of TPSignal. Lookups for state and/or behavior proceed from bottom to top through this hierarchy following the vertical tracks depending on whether type or instance lookups are being performed.

The lines within the diagram display the construction relationships which exist within the invention. Starting from the top right the lines from Object point to Function.prototype, TPMetaObjectType.prototype, and TPMetaObjectInst.prototype. These three objects are constructed using the syntax “new Object( )”. The result is that these three objects follow a constructor.prototype lookup chain that terminates at Object.prototype since Object is their constructor. This creates the root of the meta-object system. TPMetaObjectType and TPMetaObjectInst represent the two components which combine to provide the top level meta-type TPMetaObject from which all other types in the invention inherit.

For clarity in the diagram the objects created by Function are not shown with connections, however, each of the following objects was created using “new Function( )” or the function literal variant “obj=function( ){ }”: TPMetaObjectType, TPMetaObjectInst, TPObjectType, TPObjectInst, TPSignalType, and TPSignalInst. These objects, as instances of Function, are the only objects shown (other than Function and Object themselves) which can respond properly to instance allocation requests via the “new” keyword. Therefore, all instance allocation is ultimately handled by one of these objects.

TPMetaObject's Type Track constructor, named TPMetaObjectType, is responsible for creation of the TPMetaObject instance which will serve as the type proxy itself as well as the creation of any instances attached to TPMetaObject's subtype prototypes. A specific example of this prototype linkage is shown by the connection from TPMetaObjectType to TPObjectType.prototype in the TPObject Type Layer. This linkage pattern is continued in the other types as evidenced by the link from TPObjectType to TPObject (the type proxy) and TPSignalType.prototype.

On the instance track TPMetaObjectInst is the constructor function used to create public instances of the TPMetaObject type. Like its Type Track counterpart, TPMetaObjectInst is also used to create any instances attached to TPMetaObject's subtype prototypes. This is evidenced by the links from TPMetaObjectInst to myTPMetaObject and TPObjectInst.prototype as well as the links from TPObjectInst to myTPObject and TPSignalInst.prototype.

“Signal” as used here is just a specific subtype, alternately it could be titled “custom”.

Using the diagram and the discussion just provided one can work from the bottom up to see how an instance such as myTPSignal or the TPSignal type proxy will inherit properly. On the instance side from myTPSignal we can see that myTPSignal's constructor is TPSignalInst. That implies that myTPSignal's first step in the lookup chain is TPSignalInst.prototype. Following this pattern the actual lookup is clearly TPSignalInst.prototype->TPObjectInst.prototype->TPMetaObjectInst.prototype->Object.prototype. This lookup pattern is mirrored on the type side where TPSignal's lookup chain is TPSignalType.prototype->TPObjectType.prototype->TPMetaObjectType.prototype->Object.prototype. Note that all tracks ultimately merge to inherit from Object.prototype, the root of the meta-object system.

The pattern of construction shown in the TPMetaObject and TPObject Type Layers is consistent for all subtypes created using the invention. In each case, a new subtype layer consists of two constructor functions—one in each track—which perform in a manner consistent with the operation of the constructors just described for TPMetaObject and TPObject.

The following code performs manual construction of the TPMetaObject type components:

| function TPMetaObjectType( ){ }; | | |
|---|---|---|
| function TPMetaObjectInst( ){ }; | | |
| TPMetaObjectType.$setName(‘TPMetaObjectType’); | | |
| TPMetaObjectInst.$setName(‘TPMetaObjectInst’); | | |
| TPMetaObject = new TPMetaObjectType( ); | | |
| TPMetaObjectType.$setOwner(TPMetaObject); | | |
| TPMetaObjectInst.$setOwner(TPMetaObject); | | |
| TPMetaObject.$meta = | | |
| { | | |
| ‘$name’:‘TPMetaObject’, | // | the type name |
| ‘$type’: TPMetaObject, | // | the type object |

| | | |
|---|---|---|
| ‘$typec’: TPMetaObjectType, | // | the type constructor |
| ‘$instc’: TPMetaObjectInst, | // | the instance constructor |
| ‘$parents’: [ ], | // | parent (supertype) list |

| | | |
|---|---|---|
| ‘$guardians’: [ ], | // | multiple supertype list |

| | | |
|---|---|---|
| ‘$children’: [ ], | // | children (subtype) list |

| | | |
|---|---|---|
| ‘$instances’: { } | // | instance dictionary |
| }; | | |

In the previous code the first two lines create the type and instance track constructors. The next two lines use the $setName function to ensure these constructors support reflection. The fifth line creates the actual TPMetaObject type proxy. Once that object has been created it is set as the owner of the two type constructors via the $setOwner function. This ownership mechanism further supports reflection. The $setOwner and $setName functions assign a value to owner and name slots on their targets, nothing more. The final step is creation of the $meta type dictionary. This is the dictionary which contains type and instance reflection data as described below.

Each type created using the invention maintains a dictionary containing a specific set of key/value pairs. This dictionary is maintained by each type such that questions about the type, the type's supertypes, the type's subtypes, and the type's instances can be answered quickly and efficiently. Also stored are references to the track constructors so that the type object has quick access to them when responding to requests to create new subtypes or instances.

Four additional functions of particular interest are involved in the operation of the invention: addSubtype( ), addGuardian( ), create( ), and getType( ). In the preferred embodiment these functions are attached to appropriate objects in the system such that they operate as methods.

The addSubtype( ) function is attached to the top level type track constructor's prototype. In the structures just defined this makes it a property of the object TPMetaObjectType.prototype. This location makes addSubtype( ) a “type method” accessible to all type proxy objects in the system. The create( ) function is attached to the same object since it also functions as a “type method” which is used to create new instances of the type. The addGuardian( ) method follows this pattern as well.

Two separate implementations of the getType( ) function are used. One is attached to the top level type track constructor's prototype while the other is attached to the top level instance track constructor's prototype. These functions allow both types and instances to reflect properly on their type.

As mentioned earlier, a serious problem with ECMAScript is the non-existent support for calling supertype methods from within the context of a method which overrides them. The invention solves this problem through a combination of reflection to locate the “next method” in the lookup chain and a “bind” operation which ensures that the values of the originating instance are bound to the method during execution.

The first step in the process is to locate the “next method” of the same name. Given ECMAScript's support for placing functions on individual instances there is added complexity. In particular, the method that is overriding might be a method placed on a single instance that overrides a method on that instances constructor.prototype.

Imagine type A with method print which we want all instances of A to use. That implies we place print on A.prototype. But in ECMAScript you can alter individual instances so an instance “a” of type A might have a “local” print function defined by a.print=function( ) { };

In this case the a.print function's proper behavior when attempting to invoke the “next method” is to invoke A.prototype.print in some fashion that ensures the state variables which are bound to the “this” reference come from “a”. This situation is complicated when multiple levels of overriding functions exist in a deep hierarchy of types. One possible implementation of a solution is as follows:

```
TPMetaObject.addInstMethod(‘callNextMethodWithArray’,
function(theFunction, argArray)
{
  /**
  @method  callNextMethodWithArray
  @abstract  Invokes a parent function implementation. This
    implementation backs up the simpler callNextMethod( )
  @param  theFunction Function The function to “call super” for.
  @param  argArray Array Optional arguments for function.
  @returns  Object The function results.
  @since  1.0b1
  */
  var functionOwner;
  var functionName;
  var functionTrack;
  functionName = theFunction.$getName( );
  // check to make sure that theFunction really has an owner slot.
  // All objects should, but sometimes we get objects from other
  // contexts (i.e. frames) that don't even know what ‘owner’ is.
  functionOwner = theFunction.$getOwner( );
  if (notValid(functionOwner))
  {
    return this.warn(‘MethodHasNoOwner’,
        arguments.callee,
        functionName);
  };
  // figure out which track (type or instance) to follow in locating the
  // parent implementation. Notice that we don't worry about actually
  // finding the real implementation we just let JS find it for us by
  // apply( )ing whatever our parent returns.
  functionTrack = theFunction.$getTrack( );
  if (functionTrack == ‘Type’)
  {
    if (notValid(superFunc =
    functionOwner.$$meta.$parents[0].$$meta.$typec.-
    prototype[functionName]))
    {
      return this.warn(‘NoNextTypeMethod’,
        arguments.callee,
        functionName);
      };
  }
  else if (functionTrack == ‘Inst’)
  {
    if (notValid(superFunc =
    functionOwner.$$meta.$parents[0].$$meta.$instc.-
    prototype[functionName]))
    {
      return this.warn(‘NoNextInstMethod’,
        arguments.callee,
        functionName);
    };
  }
  else if (functionTrack == ‘TypeLocal’)
  {
    // local method on the type itself...
    if (notValid(superFunc =
    functionOwner.$$meta.$typec.prototype[functionName]))
    {
      return this.warn(‘NoNextTypeLocalMethod’,
        arguments.callee,
        functionName);
    };
  }
  else if (functionTrack == ‘InstLocal’)
  {
    // local method on the instance itself...
    if (notValid(superFunc =
    functionOwner.getType( ).$$meta.$instc.prototype[functionName]))
    {
      return this.warn(‘NoNextInstLocalMethod’,
        arguments.callee,
        functionName);
    }; .
  }
  else if (functionTrack == ‘Global’)
  {
    return this.warn(‘NoNextGlobalMethod’,
        arguments.callee,
        functionName);
  }
  else
  {
    return this.warn(‘InvalidFunctionTrack’,
        arguments.callee,
        functionName);
  };
  if (notValid(argArray))
  {
    return superFunc.apply(this);
  };
  return superFunc.apply(this, argArray);
}
);
```

Notice that the final few lines of the previous method use the apply( ) function to ensure that the method that is invoked is properly bound to the instance on which the method should operate.

Implementation of this solution requires that each function be made aware of its “owner” and “track” so that differentiation between type, instance, and local method implementations can be made. Owner references define the type chain while track information defines whether the receiver is a normal instance or a type instance. This data is necessary to resolve methods which might have implementations on both tracks. Unlike Java the solution provided here allows types and instances to have methods of the same name, thereby allowing a type to act as an instance in certain situations.

ECMAScript has no facilities for tracking this information, however by providing support for encapsulation and using functions to define all methods in the system we can solve that problem.

Encapsulation

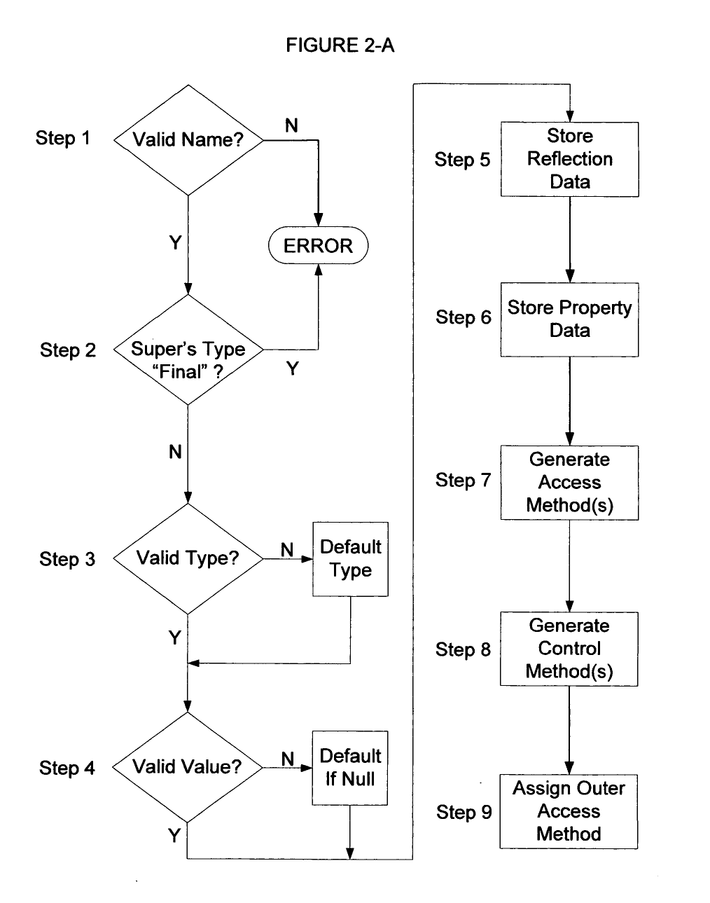

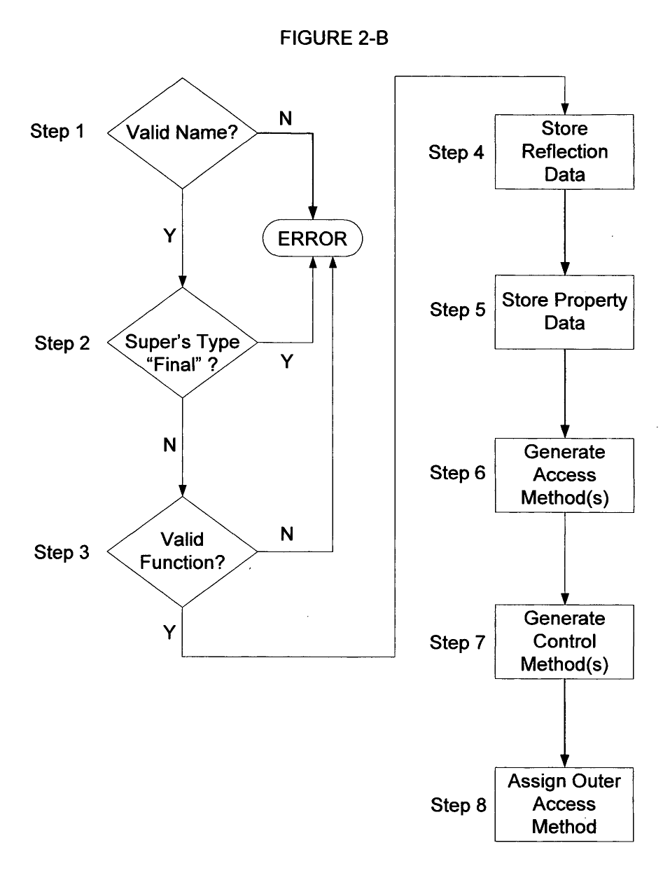

Attribute Definition—FIG. 2-A

All attribute-definition functions defined by the invention follow the general form:

add*Attribute(name, type, value, visibility, mutability, storage);

The asterisk (*) in the previous function name represents a scope of either Global, Local, Type, or Instance which determines the specific object targeted for the property. FIG. 2-A describes the process used during attribute-definition to process these parameters and complete the attribute definition process.

FIG. 2-A begins with Step 1 by checking the attribute name passed to the attribute-definition function to ensure that it is a valid name. This test can range in complexity from simply testing for a non-null value to ensuring that the proposed attribute name conforms to the naming conventions for ECMAScript attributes and that it does not collide with any reserved words or other terms which would cause problems with the definition. For example, certain terms have been found by various practitioners to reference private variables used internally by various browsers. Attributes defined with one of these names can cause difficult to find bugs. A robust implementation of the invention would check against a dictionary of such terms to ensure attribute names did not create such bugs. If the name provided passes all criteria for a valid name the definition process continues. If the name fails the test the definition process is terminated with an error.

Step 2 in the attribute definition process is to check the receiving object's supertype for any previous definition of the proposed attribute name. In particular, the attribute is checked to ensure that it wasn't previously defined as “final” in any supertype of the current target object for the relevant scope. If the value was defined as final the definition process terminates with an error. If the value either was not previously defined or was defined but unconstrained regarding redefinition the definition process continues. Should the process continue the reflection information gathered from the supertype is retained to support constraint testing in Step 3.

Step 3 in the attribute definition process is to check the attribute-definition function's parameter list for a type definition for the attribute. If the attribute has been given a type definition this type is checked to ensure that it is a valid type. Testing for a valid type in native ECMAScript implies making sure the type both exists and is an instance of Function which would allow it to operate as a constructor. In other inheritance systems, such as the one described ECMAScriptherein, the appropriate type verification function(s) would be invoked to verify the type is valid. If the type is valid the definition process continues. If the type is invalid the definition process stops and signals an error. If no type has been defined the attribute's type defaults to a system configured default-attribute-type—typically Object. In all cases the supertype is checked to make sure that if a redefinition of a pre-existing property is occurring the types match. If the types don't match the process terminates with an error.

Step 4 in the attribute definition process checks the parameter list for an initial value for the attribute. When a value has been provided this value is checked to see if it is a valid value for the attribute type defined in Step 3. The details of how such a test are performed vary. In the preferred embodiment based on the inheritance model ECMAScriptherein, the value can be queried via the getType( ) function which will return accurate type information for all instances. In standard ECMAScript the typeof( ) operator and/or interrogation of the instance's constructor function may need to be performed in an attempt to accurately determine the type. If the value is valid for the type it is held for storage. If the value is invalid the definition process terminates with an error. If no value is provided the value defaults to the result of querying the type for its default value. This is accomplished by ensuring each type can respond to a function which would return a default value such as 0, null, or the empty string.

Step 5. At this point the definition process has either terminated or we verified the attribute name, type, and value are valid and appropriate to define on the target object. Appropriate reflection data for the attribute can now be stored with the target object or type. This data includes a copy of all the parameter values provided allowing full reflection to occur.

Step 6 of the attribute definition process is to determine an appropriate storage location for the attribute. Constrained attributes obviously cannot be stored directly on the target object since ECMAScript can't natively enforce constraints on attribute access or modification. Unconstrained, i.e. publicly read/write attributes can be stored on the target object via direct assignment. In the preferred embodiment however, such direct assignment is never performed by the property-definition function itself. Instead, all data storage and retrieval is managed by a separate object referred to as the storage manager.

Using a separate storage manager ensures that all attribute access is fully encapsulated regardless of whether the attribute is publicly read/write or not. For the moment let's assume that the storage manager can make an appropriate determination of where to store the data and that it can retrieve the data when asked to do so. What is important for the operation of the invention is that since the data isn't stored locally with the target object—and only the storage manager knows where the data has been stored and how to access it—data encapsulation has been accomplished. The problem now is to open up access for authorized use.

Step 7 of the attribute definition process is the generation of access methods. For read-only properties i.e. those defined as const only retrieval functions will be generated. These functions are often referred to as “getters” since they “get” values. For read-write properties both getters and “setters” will be generated. As you might expect, “setters” are so named because they set values.

The use of a separate storage manager makes generation of setters and getters significantly easier. Since the setters and getters must ultimately communicate with the storage manager for the actual data storage and retrieval they must use the public interface of the storage manager. Using this mechanism one can see how the specific implementation details of the storage manager become irrelevant with respect to method generation.

Only the public interface which allows storage and retrieval of data is important. This is precisely what encapsulation is designed to accomplish. By generating functions which interface properly with the storage manager's public interface for getting and/or setting an attribute value the task of access method generation is complete. The specifics of the interface are not critical to the process.

Step 8 is the generation of control methods. Control methods are a special feature of the invention. Control methods are optionally generated methods which are capable of being nested to provide additional functionality. Support for visibility constraints requires the use of control methods however other uses exist. Examples are functions which log timestamps on method invocation entry and exit, log access method parameters and return values, keep track of calling contexts, and otherwise track information often useful for debugging or profiling applications. Because of the overhead they impose control method generation is controlled by several flags which enable and disable default generation of the various control methods.

Specifically, when a method function is added, the system messages the function with an asMethod( ) call. The asMethod( ) function is added to Function.prototype during system installation so that all functions can respond to it. The default implementation simply returns the receiver, the original method function. But depending on system configuration the function which is returned may be a proxy which performs other activity. A specific example follows:

```
MetaType.asLoggingMethod = function( )
{
  // have to avoid these calls since they cause recursion etc.
  var oops = [‘getName’, ‘$getName’, ‘logActivity’, ‘apply’,
      ‘asTimestamp’, ‘asString’, ‘getID’,‘addStat’,‘getStats’,
      ‘$getOID’, ‘defaultIfInvalid’, ‘isValid’,
      ‘getFullYear’, ‘getDate’, ‘getHours’, ‘getMinutes’,
      ‘getSeconds’, ‘getMilliseconds’, ‘valueOf’, ‘toString’,
      ‘isRegExp’, ‘compile’, ‘exec’, ‘test’, ‘asStackingMethod’,
      ‘init’,‘$init’,‘create’,
      ‘asLoggingMethod’];
  var n = this.getName( );
  for (i=0; i<oops.length; i++)
  {
    if (oops[i] == n)
    {
      return this;
    };
  };
  // the tricky bit here is the ‘arguments.callee.$realFunc.apply’
  // portion. When the function created here is invoked it is
  // ‘arguments.callee’. Therefore we have to make sure we put the real
  // function somewhere that the wrapper can find it. We do that by
    // programming the instance in the last few lines of this call.
  var f;
  var s = ‘var ret;’ +
      ‘TIBET.logActivity(“calling ” + ’ +
        ‘arguments.callee.$realFunc.$name + ’ +
        ‘“ with args: ” + arguments);’ +
      ‘ret = arguments.callee.$realFunc.apply(this, arguments);’ +
      ‘TIBET.logActivity(“returning from ” + ’ +
        ‘arguments.callee.$realFunc.$name + ’ +
        ‘“ with value: ” + ret);’ +
      ‘return ret;’;
  // instance program things so we can find the real function etc.
  //f = new Function(s);
  f = Function.create(s);
  f.$name = this.$name || ‘LoggingMethod’ + this.getName( );
  f.$owner = this.$owner || ‘none’;
  f.$track = this.$track || ‘none’;
  f.$realFunc = this;  // here's the function to call
  return f;
};
```

As this sample control method generator shows, control methods can be implemented as wrappers which perform activity pre/post execution. They can alternatively be complete surrogates which never invoke the original function.

Step 9 is the placement of the outermost control method (or the access method itself if no control methods are generated) on the target object. Regardless of which function is outermost and therefore will be placed on the object the name of that function will be assigned to a slot whose name conforms to a naming convention consistent with the method's purpose. If the method is a setter the name is defined as “setProperty” where “Property” is the name provided for the attribute with the first character converted to uppercase. If the method is a getter the name is defined as “getProperty” using similar name conversion semantics.

Method Definition—FIG. 2-B

All method-definition functions defined by the invention follow the general form:

add*Method(name, value, visibility, mutability);

The asterisk (*) in the previous function name represents a scope of either Global, Local, Type, or Instance which defines the target object. FIG. 2-B describes the process used during method-definition to process these parameters and complete the method definition process.

FIG. 2-B begins with Step 1 by checking the method name passed to the method-definition function to ensure that it is a valid method name. This process is analogous to the first step in attribute definition where the name is checked for collisions with reserved words, built-in properties, or undocumented private variables which might cause difficult bugs.

Step 2 in the method definition process is to check the receiving object's supertype for any previous definition of the proposed method name. In particular, the method name is checked to ensure that it wasn't previously defined as final in any supertype of the current target object for the relevant scope. Again, this is similar to Step 2 in the attribute definition process.

Step 3 in the method definition process is to verify that the value provided is actually an instance of function. Only functions can be invoked as methods so the value provided must be a function.

Step 4 is the storage of reflection data. With a proper name and function reflection data for the method can now be stored with the target object or type. As with attribute definition, the reflection data includes a copy of all the parameter values provided to the method-definition function.

Step 5 of the method definition process is to determine an appropriate storage location for the method. As with attributes, constrained methods obviously cannot be stored directly on the target object since ECMAScript can't natively enforce constraints on method execution. The preferred embodiment relies on a separate storage manager for consistency and control however, the method may be “bound” as described in the “OPERATION” section.

Step 6 of the method definition process is the generation of access methods. As with attributes, constrained methods must be invoked only be authorized requestors. To ensure that this occurs the access methods for private and protected methods much check information on the calling context to validate the caller. If the caller is valid invocation of the underlying method is allowed.

Step 7 is the generation of control methods. As with attributes, method definition control methods are optionally generated methods which can be nested to provide additional functionality. As with attribute-definition, control method generation is controlled by several flags.

Step 8 is the placement of the outermost control method (or the access method) on the target object. Regardless of which function is outermost and therefore will be placed on the object the name of that function will be set to the original method name making it transparent to the programmer that a control or access method is being invoked rather than the original function.

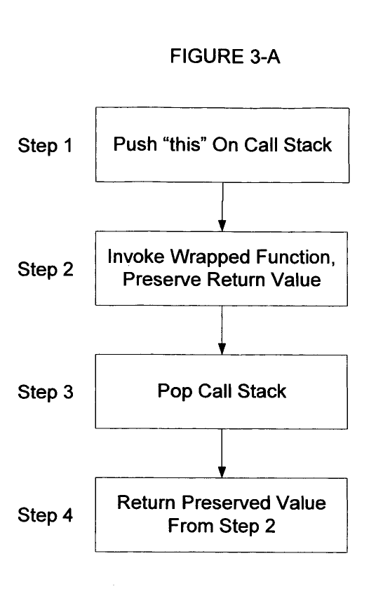

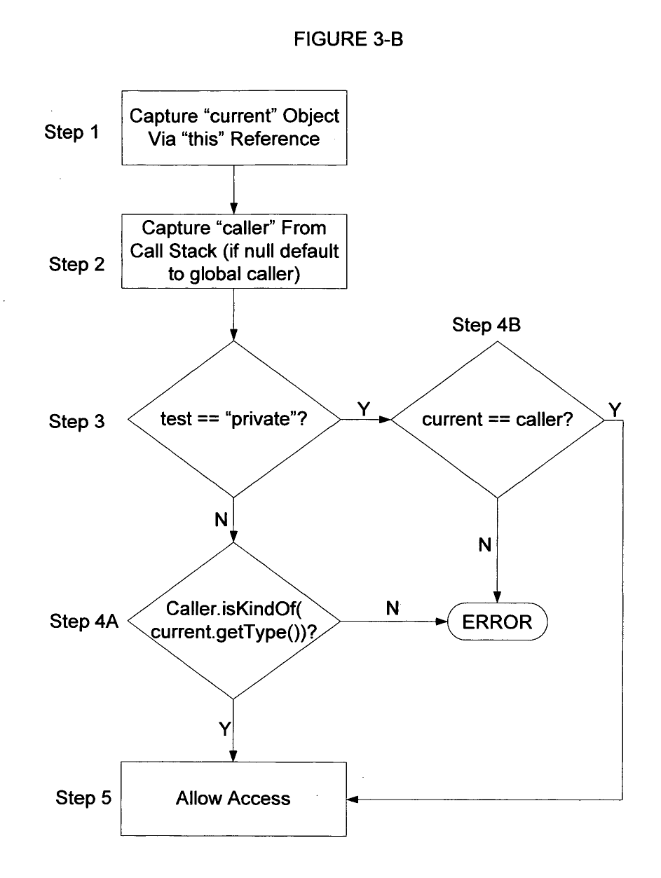

Visibility Constraint Checking—FIGS. 3-A and 3-B

To control private and protected property visibility the system must be able to determine which object is attempting access i.e. the calling context must be verified. Proper context checking requires consistent access to information on which object is calling as well as a consistent mechanism for checking the context against visibility constraints defined for the property being accessed. ECMAScript doesn't natively support either of these operations. To support these functions the preferred embodiment leverages the property-definition process just defined. The result is a pair of control methods which work together to ensure visibility constraints are met.

The first of the two context checking control methods is referred to as the call-stack manager. FIG. 3-A defines the process flow for the call-stack manager which consists of three main steps.

Step 1 of call-stack management is to perform target function invocation pre-processing. In the specific case of call-stack management the required pre-processing is to push the control function's “this” reference onto a stack known as the call stack. In ECMAScript if a function is invoked “through” an object reference as in:

someObject.someFunction( );

then within someFunction any references to “this” are assigned the object reference through which the function was accessed—in this case “someObject”. This is the mechanism ECMAScript uses to make otherwise basic functions work as “methods” in which the function has dynamic access to object properties via a standard “this” reference which can vary with each call.

Since each control method is invoked through a target object ECMAScript will assign the “this” reference to the object and therefore every control method's “this” reference will be set to reflect the object through which it was invoked. Using this knowledge it is clear that during execution of the call-stack manager the object through which the call-stack manager was invoked will be available to the call-stack manager via its “this” reference. This object will therefore be pushed onto the call stack as Step 1.

Step 2 is to invoke whichever control or access function the call-stack management function wraps. When a control method is defined during the property-definition process the control method is provided with a function to invoke at some point during its operation. This nested function may be a getter, a setter, the original method, or another control method. In any case, once the call-stack manager has performed its pre-processing and pushed the current object onto the call stack it invokes this nested function and captures any return value it may have.

Step 3 is to perform target function invocation post-processing. For call-stack management this involves popping the call stack on return from the function invoked in Step 2. Once the nested function has finished executing the object on the call stack is no longer needed. Before exit the call-stack manager pops this object off the stack along with any other data it may have pushed.

Step 4 is to return the return value captured from the nested function invocation performed in Step 2. By returning the return value of the invoked function the control function's existence is hidden from the casual observer since the invocation returns the same results which would have occurred should the original function been invoked.

The second of the two context checking control methods is referred to as the constraint manager. FIG. 3-B describes the process flow of the constraint manager control method.

In FIG. 3-B Step 1 is to capture the current object. This is done in much the same fashion as with the call-stack manager. Within the bounds of the constraint manager the “this” reference points to the current object. Alternately the object on top of the call stack can be used.

Step 2 is to capture the calling object. This can only be done accurately if the call-stack manager has been used consistently to maintain the call stack. Assuming the call stack is accurately maintained the calling object will be the object one (1) level below the top of the call stack. The object on the top of the stack will always be the current object since consistent use requires the call-stack manager to invoke the constraint manager and it will have placed the current object on the top of the stack prior to invoking the constraint manager. If the stack doesn't contain 2 objects then there is no calling object and the caller is the global object “self” or “window”.

Step 3 in the visibility test process branches based on the constraint being tested. If the constraint is for private access then the caller and current objects will be tested for equality. If the constraint is for protected access then the caller must return true when asked if it belongs to a subtype of the current object's type. Should other tests be added they would branch here as well.

Step 4-A and 4-B represent the two visibility tests previously described. Regardless of which test is performed, if the response is positive then visibility is allowed and the constraint manager returns the value of invoking its wrapped function. As with the call-stack manager the constraint manager is always provided a control method or an access method to execute. In the case of the constraint manager however, execution only occurs if the constraint is met.

Control Methods

In the preferred embodiment there are a number of other control methods which follow the same general pattern of operation as the call-stack manager. The call-stack manager performs a task, executes its wrapped function, and performs a second task prior to returning the value captured from invocation of the wrapped function. This pattern can be generalized as:
perform pre-processing
invoke and capture result
perform post-processing
return invocation result

This pattern can be used extensively to perform other tasks. In particular, using this pattern it is possible to have the pre and post processing write timestamps which document the length of time required for the invocation step. Alternately, the pre and post processing could push the function itself along with all its parameters onto a separate call stack used to trace function calls and their parameters. Or the pre and post processing steps might write information to a server or other peer for processing at that location. There are a multitude of variations here all of which can be nested by assigning each control method a nested control method to execute. The final control method in this chain is assigned the access method which ultimately operates on the data.

A specific version of a control method was previously described in the section on attribute definition where the asLoggingMethod is presented.

Polymorphism

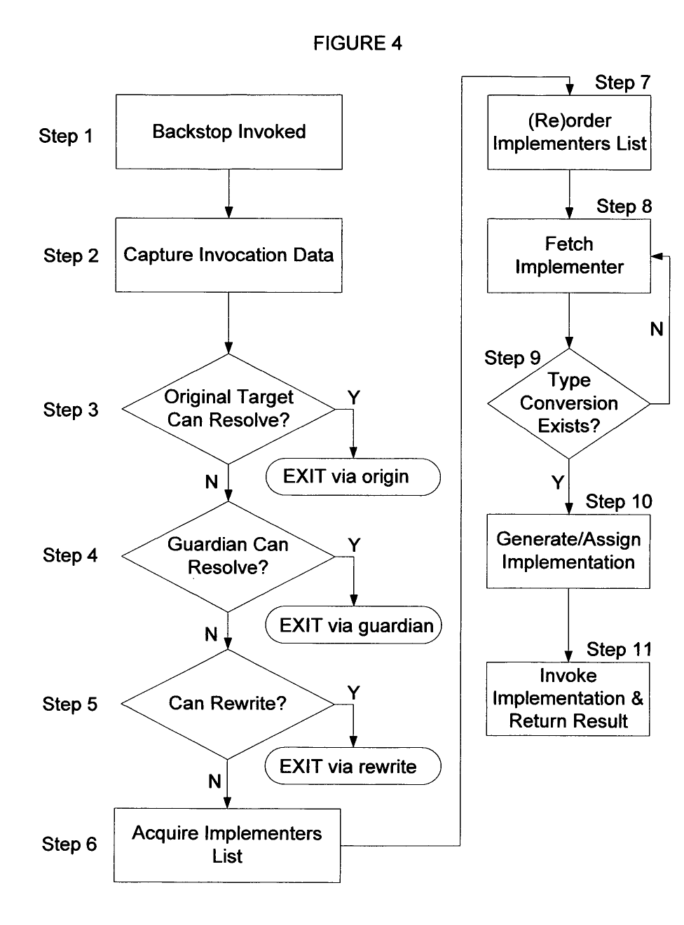

FIG. 4 defines the processing involved in the invention's polymorphic enhancements to ECMAScript.

Using the encapsulation mechanism previously described for adding/defining methods, the system creates a “backstop” method on Object.prototype which has the same name as each method added to the system. The specific mechanisms for creation of this function may vary however a function reference must be placed on Object.prototype under the method name for ECMAScript's native lookup machinery to trigger it. When a method of that name already exists on Object.prototype no backstop method is required.

Step 1 in FIG. 4 is the actual invocation of the backstop method. This invocation occurs when a message such as:

myObj.doSomething( );

is invoked and myObj doesn't have a proper implementation of doSomething( ).

Upon invocation the system uses information from the method call to determine what the originating object (this), message (arguments.callee), and parameters (arguments) are. This information is gathered in Step 2.

With information on what object, method, and parameters are being invoked the system turns to the object and asks if it can handle the method in another fashion. This provides a simple mechanism for the construction of Proxy objects. If so, the backstop process returns control to the original message target. If not, the backstop process remains in charge.

If the object doesn't have an alternative implementation for a method and the backstop must continue processing the next step is to check for guardians as shown in Step 4.

A guardian is an object that offers multiple inheritance support by providing method implementations when the receiver doesn't have a native one. This is accomplished by simply checking each guardian in order for an implementation and binding it to the object if one is found. If no guardians can resolve the method processing continues with an attempt to convert the method to another form.

By using symmetrical methods such as as( ) and from( ) to handle type conversion it is possible to do a simple method rewrite to resolve a request. For example, rather than trying to use myObj.as(“String”) we might try rewriting the method as String.from(myObj); When the incoming message matches a pattern of this type the method rewriting process is used as shown in Step 6. If the method can't be rewritten the next step is to attempt to determine which types implement the named method.

Using reflection information captured via the add*Method( ) calls defined under Encapsulation, the system can provide requesters with a list of types that implement each method signature. The next step in our processing of polymorphic requests is to acquire this list. Once acquired, an optional ordering step can be performed on the list of implementers. The nature of this ordering is best accomplished via a Strategy design pattern where different algorithms may be substituted based on system configuration.

With a type in hand that can implement the method we want the next step consists of determining whether a lossless type conversion path can be constructed between the original object and the type. For example. Strings and Numbers can typically be interchanged in a lossless fashion providing the String contains only valid digits and punctuation for the Numerical type in question.

To properly support the method being requested the system now generates a new function. The contents of this function consist of a type conversion to the implementing type, the method bind/invocation, and a type conversion to return the data in the originally messaged type. An example is shown below:

```
// HERE is a simple, non-hotspot version that works
// do this in two parts for now to ensure proper binding
// as we move along the path...if you don't split this
// out the binding doesn't work properly
//obj = anOrigin[asMethodName]( );
//return obj[aMethodName].apply(obj, anArgArray);
// here's the hotspot version
s = ‘var obj;\n’ +
  ‘var res;\n’ +
  ‘obj=this.’ + asMethodName + ‘( );\n’ +
  ‘res=obj.’ + aMethodName +
    ‘.apply(obj, arguments);\n’ +
    “return res.as(“‘ + anOrigin.getTypeName( ) + ’”);\n”;
  // Original version...no return type reconvert.
  //s = ‘var obj;\n’ +
  // ‘obj=this.’ + asMethodName + ‘( );\n’ +
  // ‘return obj.’ + aMethodName +
  //  ‘.apply(obj, arguments);’;
  if (TIBET.shouldLogInferences( ))
  {
      TIBET.logInference(‘Generating method:\n’ + s);
  };
  f = Function.create(s);
  //f = new Function(s);
  // install our new function on the receiver...next time
  // there won't be any inferencing it will just
  // fire.
  // TODO: for now we don't go further to do
  // this at the type or instance method level but
  // leave it at the local level. some performance
  // might be gained by altering that so a function
  // that's constantly targeting new instances of the
  // same time would only infer( ) on the first
  // instance.
  anOrigin.addLocalMethod(aMethodName, f);
  // here's the fun part...save the change to the
  // change log if active so next time we don't even
  // do the infer( ) to begin with!
  if (TIBET.shouldLogChanges( ))
  {
    str = ‘//\tGenerated method\n’;
    str += anOrigin.getTypeName( ) + ‘.add’;
    if (isType(anOrigin))
    {
      str += “TypeMethod(”‘;
    }
    else
    {
      str += “InstMethod(”’;
    };
    str += aMethodName + “‘,” +
      f.toString( ).replace(‘ anonymous’,”) + “;\”;
    TIBET.logChange(str);
  };
  // go ahead and run it to resolve this invocation
  return anOrigin[aMethodName].apply(anOrigin,anArgArray);
```

The previous code shows several alternative implementations which might yield positive results. The active version creates a function and adds it via the add*Method( ) call to the original target object. This ensures that for each target a particular backstop invocation will only occur once. The final few lines also show how the resulting method source code may be saved to a change log or other data structure so it can be made persistent on a remote server.

The last line of our example is the actual invocation. Notice that the method slot is on the origin is referenced by name (anOrigin[aMethodName]) to help locate the proper method. The apply( ) function ensures proper binding of instance data to the method. This corresponds to Step ? in FIG. 4.

Reflection

The core of the reflection subsystem is the $meta dictionary described in detail in the section on Inheritance. This dictionary holds keys and values that track supertype (parents), subtypes (children), multiple supertypes (guardians) and the type and instance track constructors. This information can also be augmented with tracking of attribute and method declarations as needed. The $meta dictionary is maintained by a set of functions which, in the preferred implementation follow a naming pattern of add* where * may be InstAttribute, InstMethod, InstConstant, LocalAttribute, LocalMethod, LocalConstant, TypeAttribute, TypeMethod, TypeConstant.GlobalAttribute, GlobalMethod, or GlobalConstant. Each function updates the appropriate component of the reflection dictionary to ensure accuracy of reflection data.

### OPERATION OF INVENTION

Use of the invention first requires loading the ECMAScript source code which implements the functionality of the invention into a web-browser or other execution environment capable of executing ECMAScript source code. While the approach used to accomplish this task can vary depending on the particular environment, in the common case of a web browser, the mechanism used can follow one of several forms.

First, the standard HTML <SCRIPT> tag may be used. In this approach the ECMAScript source code implementing the invention can be integrated with any web page by placing the source code in a file—possibly containing other ECMAScript—and using the following HTML syntax:

s<SCRIPT LANGUAGE=“JavaScript” SRC=“Invention.js”></SCRIPT>

In the line above the invention's source code is assumed to reside in a file named Invention.js. The web browser, upon seeing this directive will request the Invention.js file from the web server and integrate the contents of that file with the current page at the location of the <SCRIPT> tag.

As the page's source code is interpreted by the browser the functionality of the invention will be enabled for any ECMAScript which occurs later in the page or which accesses that page from an external frame. This strategy is the most prevalent mechanism used by today's web sites.

Second, a “server-side include” using an SHTML file could be utilized. In this model an HTML tag following this syntax is used:

<!--#include type=virtual src=”Invention.js-->

In this case a properly configured web server will automatically replace this line with the contents of the named file. As with the <SCRIPT> tag example, any subsequent ECMAScript on the page containing this tag will have the benefit of using the invention. The difference between the two approaches has to do with where the ECMAScript source is integrated with the enclosing page, on the client or on the server.

Inheritance

Once the invention's source code has been properly loaded and processed by the execution environment as defined previously, the first operational element in the inheritance subset of the invention is the creation of a new subtype.

Creating a new subtype via the invention is accomplished by messaging a supertype as follows:

TPMetaObject.addSubtype(“TPObject”);

or

TPObject=TPMetaObject.addSubtype(“TPObject”);

In both of the previous examples the TPMetaObject subtype “TPObject” is created and assigned to the TPObject key. From that point forward referencing TPObject at the global scope will return a reference to the object acting as the type TPObject. Note these object names are consistent with those in FIG. 1 to facilitate the discussion.

In response to the particular addSubtype( ) call made here, the two constructor functions TPObjectType and TPObjectInst are created to service the needs of the type and instance tracks of the TPObject type respectively.

To create these functions the receiving type proxy, in this case TPMetaObject, creates two new Function instances using standard ECMAScript syntax, looks up the appropriate constructors for each track in its type dictionary and assigns the prototype objects of the newly created subtype constructor functions to reference new instances of its corresponding track constructors.

While the code to perform these tasks is generated dynamically by the addSubtype( ) function and executed via the ECMAScript eval( ) call a static example of this process was defined in the previous section where the source code used to create the TPMetaObject type is presented. What is missing from that example is the configuration of the two track constructor prototype objects which would be accomplished using the following syntax:

TPObjectType.prototype=new TPMetaObjectType( );

TPObjectInst.prototype=new TPMetaObjectInst( );

In the example shown here the two track constructors for TPObject, TPObjectType and TPObjectInst have their prototypes set to instances of their supertype's (TPMetaObject) corresponding track constructors. This is the pattern followed for all subtypes created by the invention.

In addition to creating the type and instance track constructor functions, the addSubtype( ) function also maintains reflection information which can later be used to query the system regarding the type hierarchy. This allows reflection functions which return lists of supertypes or subtypes for a particular type, or which can respond accurately to questions regarding whether a particular type object belongs to a particular type hierarchy, to be implemented.

When creating a new subtype, the addSubtype( ) function adds the subtype object to the subtype array in the supertype's type dictionary. Also, the subtype's supertype array is configured to reference the supertype which is creating it as well as any other supertypes in the inheritance hierarchy. These references allow the two type objects to accurately respond to queries regarding their supertype and subtype relationships without the overhead of reconstructing this data.

As described earlier, once the constructor functions on each track of a subtype are created they have their prototype objects updated to reference instances of their supertype track constructor counterparts. As FIG. 1 and the earlier code examples show, the prototype object on TPObjectType is set to an instance of TPMetaObjectType while the prototype object on TPObjectInst is set to an instance of TPMetaObjectInst.

Given that ECMAScript follows constructor.prototype references for state and behavior the TPObject type proxy created by addSubtype( ) follows a lookup chain consisting of:

TPObject

TPObjectType.prototype

TPMetaObjectType.prototype

Object.prototype

From this lookup chain we can see that, in the structure created by the invention, types in the form of type proxies are able to follow complex multi-level inheritance chains while still leveraging the native ECMAScript lookup machinery. The same is true on the instance track.

Activation of the instance creation process to trigger invocation of the instance track constructor is performed via a function call similar to:

newInstance=TPObject.create( );

As with the addSubtype( ) function the create( ) function has the ability to track the individual instances it creates. By storing appropriate information, queries to the type object requesting lists of instances or verifying type inclusion can be performed. In particular, for each instance being tracked a unique Object Identifier or OID is generated. This OID becomes the key in the type's instance dictionary while the value in that dictionary is the instance itself.

When queried for a particular instance the instance dictionary returns the instance by accessing the appropriate value via the OID. When queried for all instances, the type simply returns the dictionary containing all instances. Iteration on this dictionary yields a complete set of all instances available for the type.

The create( ) function—for purposes of actual instance creation—effectively translates into:

new this.typeDictionary.instanceConstructor( );

where this is the ECMAScript syntax for referencing the current object which in this case would be TPObject. In the example, typeDictionary is assumed to reference TPObject's type dictionary, and instanceConstructor is assumed to reference the type proxy's instance track constructor. Invoking this function by placing the execution operators “( )” at the end and using the new keyword initiates the ECMAScript instance-creation/instance-initialization cycle.

For the TPObject type proxy the instance track constructor is TPObjectInst so the final translation results in:

new TPObjectInst( );

The result of this transparent translation process from TPObject.create( ) into the traditional ECMAScript new TPObjectInst( ) call is what allows programmers using the invention to operate with complete syntactic consistency with standard ECMAScript while garnering the benefits of robust multi-level inheritance.

Instances created by the instance track constructor are configured such that proper inheritance semantics are maintained. In FIG. 1, the specific instance of TPObject labeled tpObject created in this fashion follows a lookup chain consisting of:

tpObject

TPObjectInst.prototype

TPMetaObjectInst.prototype

Object.prototype

In both the type and instance cases it can be seen that the objects and functions created and managed by the invention ensure that robust multi-level inheritance of both state and behavior occurs for both types and instances while also ensuring accurate reflection data is maintained.

Maintenance of accurate reflection data is critical to the overall process.

When a type or instance needs to access its type it relies on the reflection data maintained by the system to ensure it is directed to the proper object. If the ECMAScript constructor.prototype reference is incorrectly assumed to be accurate then the type returned would refer to either a type track constructor or an instance track constructor which isn't always accurate. Instead, the invention defines a common function “getType( )” which is provided for both types and instances such that the appropriate type object is returned.

Specifically, the getType( ) function ensures that for all instances the type returned is the special type instance created by the type track constructor. For the type objects themselves the result is the actual constructor function which created the instance. The use of the getType( ) function combined with the objects, functions, and connections managed and maintained by the invention allows instances of any type to acquire a type object which properly inherits state and behavior from its supertypes. This ensures that instances created using the invention can rely on the fundamental guarantee of object-oriented programming—they will function effectively as instances of their supertypes without method resolution failure when a type method is invoked.

Encapsulation

All property definition functions use a standard pattern defined earlier:

add[Global|Type|Inst|Local][Attribute|Method](parameters);

Due to ECMAScript's lookup mechanism there are four locations where a property may be defined which will significantly alter how that property will later be found during inheritance processing. For the preferred embodiment these locations are given the names Global, Type, Inst, and Local.

Global refers to the global scope implying the property should be available to all objects in the system. For a global property the property or its access methods will be assigned to the “window” object or the global object reference “self”.

Type refers to type scope which, in standard ECMAScript, implies placing the property or its access methods directly on the type object. In the preferred embodiment which is based on the enhanced inheritance framework described in “A Method Supporting Improved Inheritance And Reflection In ECMAScript” the target would be refined to the type proxy's type track constructor prototype.

Inst or Instance refers to placing the property or access methods where all instances of a type will locate it. In standard ECMAScript this would mean assigning to the type's prototype object. All instances created by the type would then find the property via their constructor.prototype references.

In the preferred embodiment which is based on the enhanced inheritance framework described earlier the target would be refined to the type proxy's instance track constructor prototype.

Local refers to placing the property or its access methods on the target object itself. With ECMAScript's ability to support instance-specific customizing it is possible to place properties directly on any object in the system. The resulting property will only be found on that object—unless of course the object in question is acting as a prototype for some constructor.

Regardless of the specific object used as the target of the property definition method the ultimate target may be “adjusted” based on the scope (Global, Type, Inst, or Local) defined in the call. Thus, if an instance is messaged but the call is addGlobaLAttribute( ) the instance will not be the ultimate target. Likewise if a type is messaged but the call is addInstMethod( ) the ultimate target object will be the type's instance track constructor prototype (or the type's prototype in standard ECMAScript without the benefit of improved inheritance). This is known as “scope adjustment”.

The general operation of the property-definition functions was defined step-by-step earlier however the steps are worth repeating. First, the property name is tested for a null value an other invalid value. Then supertype constraints such as “final” are checked to ensure compliance. In the case of attributes, the property type is checked for validity or defaulted to a standard type if null. The property value is checked or—for attributes—defaulted if null by querying the type for a default value. Reflection data is then stored on the scope-adjusted target object. A separate object responsible for data storage (the storage manager) is messaged to store the data. Access methods are generated according to the mutability and visibility constraints defined. Control methods are optionally generated and the outermost access or control method(s) are assigned to the scope-adjusted target for use. Detail on each of these steps is provided below.

Property name testing is a straightforward test which can be a simple test for a null value or a check against a dictionary of keywords and other terms which might cause problems. Sample implementations of these two checks would take the following form:

```
// test for null or empty string
if (propertyName == null) || (propertyName == ”)
{
  return;
}
// test for inclusion in “exception dictionary”
if (exceptionDictionary[propertyName] != null)
{
  return;
}
```

The content of the exception dictionary would consist of keys which define all known ECMAScript keywords, reserved words, global properties, DOM object property names (particularly those on the window object since they appear as global variables), and private variables found to collide.

Supertype constraint testing implies supertypes are tracking constraint information. Such data is stored during the execution of the property-definition functions described by this invention. The specific data structures used to store the information can vary.

The preferred embodiment is based on the inheritance framework defined herein and leverages the type dictionary used to store reflection data for that invention. In particular, that dictionary is augmented with the following general keys:
type_methods
type_attributes
inst_methods
inst_attributes
local_methods
local_attributes

Each key referenced above contains a dictionary whose keys are property names and whose values are themselves dictionaries containing reflection data. Here's an example showing a portion of the entire dictionary structure focusing on the type method table $tmtab:

```
type.$meta =
{
  ...
  ’$tmtab’ :
  {
    ...
    ’getType’ :
    {
      ’mutability’ : ’final’,
      ’visibility’ : ’public’,
      ’type’ : ’Object’,
      ...
    },
    ...
  },
  ...
};
```

As the sample shows, the augmented type dictionary from the inheritance system now contains a “type-method-table” $tmtab containing a key for each method and a dictionary containing the parameter information passed to the method-definition function which defined that method. This information can be quickly checked for constraints on a particular method or attribute.

Type information can be provided in either String or Object form. If a String is passed the type can be acquired via:

type=self[theString];

If this test fails the type isn't valid. If the type object is returned or if the type was supplied directly to begin with the next check is whether the object can actually be used as a type. In the preferred embodiment a function is Type( ) is used to make this determination. The implementation of the is Type( ) function depends on which inheritance model is currently being used. Again, the preferred embodiment uses an enhanced model such that the implementation of is Type( ) will return true if the object in question is a type proxy which can be tested by looking for the existence of the $meta type dictionary. In standard ECMAScript the is Type( ) call would be implemented by testing whether the typeof(object)==“function”.

Value testing requires checking whether a particular value belongs to the type defined or a subtype of that type. This is a tricky test given standard ECMAScript. The implication of this test is that the value will function effectively in the role required of the property being defined. Unfortunately, as described in detail previously, instances in ECMAScript cannot be guaranteed to function effectively as instances of their supertypes. This is a primary reason this invention uses the inheritance model of this invention as the foundation for its preferred embodiment.

Given an inheritance model which ensures that instances function effectively as instances of their supertypes the test for whether the value “isKindOf” the defined type will help ensure that the program will not fail due to a type mismatch. In the preferred embodiment this test can be performed by checking the type's supertype information stored in the type dictionary.

As described in the discussion on supertype constraint testing the property-definition methods save reflection data for later use. One reason is specifically to support such supertype constraint testing. The data storage mechanism in the preferred embodiment is simply to save the parameters provided to the property definition function in the type dictionary under the appropriate key. In the example presented earlier the type method “getType” was displayed within the type dictionary. Here is the property-definition method call which would have defined that method:

```
TPMetaObject.addTypeMethod(
  ’getType’,
  ’Object’,
  function( ){...},
  ’public’,
  ’final’
);
```

Within the implementation of the addTypeMethod call presented here the call would have taken the values for each parameter and simply created a new dictionary with the proper data and placed it in the type's type method table. The result is reflection data ready to respond to any requests.

Maintaining separate data storage is critical to protecting the encapsulation boundary promised by the invention. The preferred mechanism for supporting this data hiding is the use of an external storage manager. The implementation details of this object are not critical to the operation of the invention but the use of a consistent storage and retrieval interface is. One possible implementation would use the following methods to define, store, and retrieve data:
storageManager.define(this, name, type);
storageManager.store(this, name, value);
storageManager.fetch(this, name);

For all attributes a getter consisting of a call to the previous storageManager.fetch( ) function is generated. For writable attributes a setter consisting of a call to the storageManager.store( ) function is also generated. Using a consistent programming interface via an object like the storage manager utilized here allows access method generation to be performed more easily.

It should be noted that for trivial setters and getters which do not require processing logic beyond simply hiding the data for visibility purposes that a pair of standard setters and getters can be used. The preferred embodiment of these standard functions resembles:

```
function set(attributeName, attributeValue)
{
  storageManager.store(this, attributeName, attributeValue);
};
function get(attributeName)
{
  return storageManager.fetch(this, attributeName);
};
```

Wrapping these primitive but standard functions in appropriate control methods is sufficient for most purposes. When invoked through the appropriate object reference they will correctly access the storage manager to either set or get the proper instance-specific value.

This is the point at which copy-on-write can be preserved for attributes which are reference types. By checking the type of the attribute in question the access methods which control access to these objects can be generated to create a new Object or Array as needed to support proper behavior.

In the preferred embodiment a set of configuration parameters are used to define whether the system should enforce visibility and/or mutability constraints or generate other control methods. Since the enforcement of these constraints can be resource-intensive a set of system-wide flags is used to enable or disable default enforcement. This strategy is followed for control methods which log access, track execution times, and manage debugging state as well. Each control method has a flag defined for it which determines whether that control operation is in effect. For example, if the flags for call-stack management, constraint management, timestamps, and function call tracing are on then four separate nested control functions will be added to each getter or setter which is generated. From this it is clear to see why these flags are off by default and would normally be used only during debugging cycles to ensure robustness. For production operation these flags would typically be disabled.

Control methods are typically generated dynamically. Here is an example which traces function calls:

```
s = ‘var ret;’ +
  ‘logActivity(“calling ” + ’ +
    ‘arguments.callee.$realFunc.$name + ’ +
    ‘“ with args: ” + arguments);’ +
  ‘ret = arguments.callee.$realFunc.apply(this, arguments);’ +
  ‘logActivity(“returning from ” + ’ +
    ‘arguments.callee.$realFunc.$name + ’ +
    ‘“ with value: ” + ret);’ +
  ‘return ret;’;
f = new Function(s);
f.$realFunc = this;
return f;
```

In the previous example, a logActivity( ) function is assumed which would keep track of all log entries and write them to an appropriate target location—perhaps a CGI-based trace file. The sample code just shown assumes the original function being wrapped is being messaged such that the “this” reference refers to the “real function”—the function being wrapped.

The result of execution of the previous generation code is a function which will log the name and arguments of calls to the real function, invoke the function, and log the name and return value of the real function. This dynamic control method generation follows our generic control method pattern of pre-process, invoke, post-process, return which can be used to support a multitude of features.

As was noted earlier, for method definition functions the type parameter specifies the return type of the method if any. If a return type is specified the method itself may be wrapped in a function which ensures the return value conforms to the return type specification. An example might be constraining the return value to be of type String. The function would then be wrapped as in:

```
function returnValueChecker( )
{
  var returnValue;
  returnValue = originalFunction.apply(originalFunction, arguments);
  if (typeof(returnValue) != “string”)
    alert(“Function Return Type  Exception”);
  return returnValue;
}
```

This return-value constraint function could be dynamically generated using the same approach defined previously for the method call tracing function. Note that an approach very similar to this can be used to type-check parameters by augmenting the setter functions generated for attributes. Specific type-checking methods can alternatively be wrapped around the primitive setters to modularize the process of type-checking at the expense of additional function call overhead.

The final step is property assignment. In the case of attributes the access method names are generated according to a set of naming conventions for getters and setters. These access methods are then assigned to the scope-adjusted target object based on the rules specified earlier for determining the true target object. For method definition the method placed on the scope-adjusted target object during the final step must use the name provided for the original method. This completes the processing cycle for both attribute and method definition functions.

The following source code provides a concrete example of visibility constraint management:

```
//  the call stack
self.callStack = [ ];
//  control method to push and pop caller onto stack
function stackManager(f)
{
  var ret;
  callStack.push(this);
  ret = f( );
  callStack.pop( );
  return ret;
};
//  control method to check caller against “this” which would
//  ensure access only allowed from within the same object (private)
function accessChecker(f)
{
  var caller = callStack[callStack.length − 2];
  if (caller == this)
  {
    return f( );
  }
  else
  {
    alert(’visibility constraint violated’);
  };
};
//  define an object “x” with a private function
x = new Obiect( );
x.stackManager = stackManager;
x.accessChecker = accessChecker;
x.$privateFunction = function( ) {return ’private!’};
//  define a control method which uses the stack management and
//  privacy checker control functions to wrap the actual function
x.controlMethod = function( )
{
  return x.stackManager(x.accessChecker(x.$privateFunction( )));
};
//  put the control function in place of the actual function
x.privateFunction = controlMethod;
//  define an object “y” which will attempt to run x's private func.
y = new Object( );
y.stackManager = stackManager;
y.snooper = function( ) {return y.stackManager(x.privateFunction( ))};
//  try to run the function
y.snooper( );
```

The result of executing the previous code is an alert panel stating “visibility constraint violated”. This works because when y.snooper is run the stackManager function pushes y onto the call stack since within the execution of y.stackManager( ) “this” refers to y. When the function x.privateFunction runs it pushes x onto the call stack for the same reason. The accessChecker function then looks at the stack indexing as needed to skip the current object (x) to acquire the caller (y). The check for whether the caller (y) is equal to the current object (x) fails and the result is a visibility constraint exception since “private” implies access is allowed only from within the object itself

Obviously manual configuration of this set of structures is tedious when programming large systems but the operation of the invention should be clear with respect to the specific operational elements required to enforce visibility constraints effectively. The preferred embodiment of the property definition methods ensures that the configuration of control functions following the pattern defined above happens automatically during the property definition operation so that the manual configuration performed in the previous example is not required.

One element is critical. When creating any redirection of functions by hiding them and accessing them either via access methods or control methods, the functions must be “bound” to the proper object during invocation. As discussed earlier regarding visibility constraints when a function is invoked “through” an object reference the function's “this” reference is updated to refer to the object through which it was accessed. This process can be though of as “binding” the function to the object. Such functions are considered “bound”.

Methods in particular must be bound to the object on which they should operate since by definition they are expected to access instance data. This requires that they be accessed “through” the instance. The built in apply( ) function allows this operation to occur. The apply( ) function takes an argument referring to the instance through which the function should be invoked and a second argument containing an array of arguments to be passed to the function when it is invoked. Using apply( ) it is possible to ensure that all methods are properly bound even if the method in question does not reside on the object in question.

Pre-5.5 versions of Internet Explorer do not support apply( ). This means to support cross-platform functionality an emulation of apply must be constructed. Emulating apply( ) is summarized in these three steps: first, the function should be placed back on the original object using a unique name, second, the function is invoked through the object using the unique name, and third, the function is then removed from the object using the delete( ) operation. The following function provides a way to leverage ECMAScript's closure behavior to accomplish the same task:

```
function bind(aContext)
{
  var myOID;
  var retFunc;
  myOID = this.$getOID( );
  aContext[myOID] = this;
  retFunc = function ( ) {aContext[myOID](arguments[0])};
  return retFunc;
}
```

In this case the function returned as retFunc is bound to the proper context automatically due to the nature of ECMAScript's closure behavior. Regardless of where the function is invoked it will be bound to the object provided as aContext.

Of particular note is the use of a unique OID or Object ID. This is critical to success. To support polymorphism methods must be able to overload the same string name. In other words, it must be possible for the system to have several “print” methods. To allow a particular version to be bound for execution without corrupting an existing version another name must be used when placing the function on the object prior to invocation. The preferred embodiment uses a unique ID generation function to assign all objects an OID. This OID is then used as the method name for the binding process shown previously. Only in this fashion can polymorphism be fully supported.

Polymorphism

Operation of the inventions' polymorphic system is automatic when invoking methods. A standard method invocation will automatically trigger the appropriate method backstop function assuming that the invention's encapsulation functions for method registration are utilized or some other form of method registration occurs.

For example, assuming the addInstMethod( ) call was used to place the ‘round’ function on Number.prototype all numbers will respond to round as in:

(123.45).round( );

Also assume that Strings have been updated with an asNumber( ) method via addInstMethod(‘asNumber’). The combination of registering functions in such a way that implementers of a particular method signature are known and registration of available type conversions is what is required for operation.

Given this scenario the invention's polymorphic behavior will be invoked by the following:

“123.45”.round( );

String.prototype.round does not exist at the time of the first invocation. Instead, the Number.prototype.round registration causes a backstop method to be placed on Object.prototype under the name ‘round’. This method is triggered on invocation of “123.45”.round( );

The process presented in the previous description of invention section is initiated in response. No other work on the part of the developer is necessary.

Having used addInstMethod to define a ‘round’ function on Numbers and an asNumber method on Strings the system will know that it can use asNumber to convert “123.45” into 123.45 and then invoke round( ) on it. The result is a string containing “123” after the system converts the result back into the original type, String.

Reflection

Use of the reflection subsystem is via a set of functions which encapsulate the $meta dictionary to allow changes in the data structure. These functions follow a common naming pattern in the preferred embodiment of get* where * represents LocalAttributes, LocalMethods, LocalConstants, InstAttributes, InstMethods, InstConstants, TypeAttributes, TypeMethods, TypeConstants, GlobalAttributes, GlobalMethods, or GlobalConstants. A second set of functions using the has* pattern and the previously mentioned suffixes can be used to test for a particular property.

### ADDITIONAL EMBODIMENTS

Inheritance

The connectivity between the type proxies and track elements, in particular the type and instance constructors and their relationships to their supertype track constructors, must be maintained if the built-in ECMAScript lookup mechanism is to be leveraged; however, it is possible to augment this structure with the use of instance programming techniques. Without altering the lookup chains it is possible to copy state and behavior from several objects onto the prototype objects which form the backbone of the inheritance hierarchy.

The result of copying state and behavior from additional objects provides a form of multiple inheritance. The term typically used to define this approach is “mixins”. The addition of a mixin( ) function to our previous addSubtype-only model would support mixins. This function would be attached to the same target object as the addSubtype( ) function. Using reflection the mixin( ) function would add methods and attributes to the target object. If this target was either a type or instance prototype object then instances below that prototype on the lookup chain would be automatically augmented.

Since the invention supports inheritance from both an instance and type perspective the concept of multiple inheritance can clearly be applied to both types and instances. In other words, types can multiply inherit from other types just as instance behavior can be inherited from multiple supertypes. This should be apparent from the fact that types are simply instances. The result of this fact is a system in which types can be composed via multiple inheritance from other types in a true meta-object system fashion.

A preferred embodiment of the mixin( ) function would make use of accurate reflection data maintained on each object regarding the attributes and methods which are available to the object. ECMAScript does not maintain such information in an accurate fashion however the mechanism proposed herein for encapsulation would work effectively. The reflection data stored by the property-definition functions could easily be integrated with the type dictionary such that a single dictionary containing both inheritance and encapsulation data was maintained. The resulting unified type dictionary would be queried when copying state and behavior in support of multiple inheritance to ensure accuracy and efficiency in the copy.

One challenge faced in using the copy-down strategy for multiple inheritance has already been discussed relative to prior art. In particular, once the copy has been made it is difficult to maintain the dynamic nature of the language. For example, if a copy of state and behavior has been done in our MyType example above and then additional state or behavior are defined on PersistentType, the new information won't make it onto MyType without additional work.

This problem can be solved using event notification. With proper event notification infrastructure in place, state changes to the type dictionaries can trigger automatic update of dependent types with respect to the state and behavior which was copied. Using the mechanism defined herein a similar event mechanism the type which is adding a supertype, MyType in the previous example, would become an observer of state change notifications originating from PersistentType. When a state change event was signaled by PersistentType, MyType would reevaluate its copy of functionality and state from that mixin and update its copy accordingly. By leveraging this notification mechanism the type dictionaries underlying the multiple inheritance strategy can be maintained automatically.

The copy-down and notification-based update strategy just described can be used independently of any inheritance mechanism to optimize method and state lookup on particular instances. In deep object hierarchies the task of finding state or behavior up a long chain of prototypes can affect performance. This can be counteracted by using the copy-down strategy just discussed.

For example, if an object is about to be utilized in a loop that must run 10,000 iterations and the object is a member of a deeply nested type whose lookups may take up precious time, the object can be optimized as follows:
Copy all state and behavior from all supertypes—beginning with the supertype closest to the object and work up to the top of the inheritance hierarchy—onto the object. Don't overwrite any property which is already defined locally on the target object in the process.
Have the object observe all supertypes for state change notifications regarding their definitions of state and behavior.

The result of this process is that all lookups occur locally on the object and the extra overhead of traversing the hierarchy is eliminated. Depending on the complexity of the object and the time involved in each loop this process has the potential to improve performance.

Once the loop has been exited the object can either remove the local modifications and ignore further notifications of state changes from its supertypes or it can simply remain in an optimized state. This strategy can be easily wrapped into a function (optimize( )) which would perform the copy and create the necessary event observations.

The hypothetical optimize( ) call could optionally take a list of properties to optimize as a way of limited the work to optimization of only those properties which would be accessed during performance intensive times. It should be noted that this particular strategy could be employed in any language which supported instance-level programming or specialization and is not specific to the ECMAScript language or the inheritance model described here.

The invention's type reflection data can be augmented in many ways. As mentioned previously the type reflection dictionary can be expanded to contain information on methods and attributes defined for the type.

Additionally, the reflection data can be expanded to include additional inheritance data, encachements of reflection results, data management information for instances such as indexes of instances matching particular criteria, etc. There are a multitude of options which might be employed here.

Encapsulation

There are a multitude of possible implementations of a storage manager. The particular nature of implementation isn't critical to the operation of the invention beyond specifying that the storage manager be able to save an object's attribute data and retrieve it when necessary. A specific implementation which would suffice would be to use a “peer” object for each instance in the system and store the data with the peer. When asked to save state the peer would be updated via:
peer[propertyName]=propertyValue;

When asked to retrieve the data the implementation would resemble:

return peer[propertyName];

It is possible to extend the concept of managing state separately from the instance to the point where the state resides on a separate server or separate client.

With remote storage, the actual physical data may reside in a database server and the setter and getter functions which are generated are actually nothing more than database access methods. Getters and setters in this model would access their repository via CGI calls executed via <FORM> elements or via a socket interface provided by an applet, plug-in, or other browser add-on. Encapsulation would ensure that the requester remained unaware of the physical location of the data in question.

Polymorphism

The possible extensions to the polymorphic subsystem are many.

The current design utilizes “forward lookup” semantics based on chaining as( ) methods. If as( ) methods convert objects into a new type, from( ) methods create new instances of the receiving type from the object passed as the parameter to from( ). So String.from(123) would return “123” while “123”.asNumber( ) would yield 123. This symmetry can be leveraged in the inferencing process. By adding a check for from( ) operations on the other types in system we can quickly add “reverse lookup” working from the target method back to the origin via from( ) rather than forward via as( ).

Combining these two strategies into a “pong lookup” where we go forward and backward as needed to look for as( ) chains that lead to from( ) chains that lead to new as( ) chains is the obvious next step. What might not be is that get( ) is a rough synonym for as( ). That means that if an as“Type” isn't found the system will look for get“Type” methods as an alternative.

The current design centers on having each individual lookup “policy” work separately and to allow the engine to be configured by adding one or more policies to it. The engine will at that point iterate over the policies looking for a solution via each policy. The result will be a highly configurable engine which will provide significant flexibility to developers. policies can themselves be grouped into sets which can be used as higher level “Strategies”.

An additional class of policy which may not be obvious derives from the fact that JavaScript functions aren't bound until runtime. Using that it is conceivable to simply follow an approach in which the attempt( ) call is leveraged to try each implementation of the named method by binding it to anOrigin. If the invocation throws an exception the system rolls back and tries again until an operation returns a defined value. This is a Prolog-style inference policy try until success) which is straightforward to implement via attempt( ).

An extreme policy would be the “WAG” policy in which the system simply finds a version the method with the proper name and, if no ‘this’ references are found, bind( )s it and runs.

This could be controlled via a flag some level of “strictness” for the engine which order policies based on how strict they are in checking for certain match criteria. To control the number of lookup levels the inferencing should use the engine will be instrumented with control flags to allow the programmer to tune the inferencing paths taken. This concept can be generalized to a parameter known as the “depth” which would limit the inference path length.

Reflection

A clear augmentation of the reflection system is to capture data on attributes, methods, constants, etc. in the $meta dictionary rather than computing some of this information at runtime. This would provide faster reflection access at the possible expense of accuracy when developers fail to use the proper access methods to adds or gets attributes, methods, or constants.

### ALTERNATIVE EMBODIMENTS

Inheritance

Clearly the functions used to create new instances and new subtypes do not need to be methods on the type proxy. They could just as easily be global functions which take parameters specifying which type is involved in the operation. The use of a method simplifies the process by implying the type via the “this” reference typically used in method implementations but is not critical to proper operation of the invention.

With respect to the structural arrangement of the top-level prototype objects used, in FIG. 1, both the TPMetaObjectType.prototype object and the TPMetaObjectInst.prototype object are instances of Object. This could be altered such that Function.prototype was added to the lookup chain on the type track by using new Function( ); to create TPMetaObjectType's prototype. Alternatively, the prototype instances could be created from yet another type such as a hypothetical TPType (not shown) which would provide common behavior which both tracks would inherit without forcing functionality to reside on Object.prototype. As can be seen from the example, there are a multitude of variations regarding which constructor.prototype object might be referenced by the top track constructors.

While it may not be clear from the previous discussions there can be multiple top-level types in the invention. TPMetaObject is not special in that a second inheritance hierarchy using a different root class can be created using the same mechanism shown in the code example documenting the creation of TPMetaObject and its attendant data structures.

With respect to reflection, the data for type hierarchies may be stored in a multitude of alternative data structures and may take a variety of forms. The keys themselves can obviously use different names or may be restructured into different data structures. Variations here are endless.

Encapsulation

An alternative mechanism for hiding the data of an object such that it cannot be accessed without using functions is possible using a particular feature of ECMAScript functions. In ECMAScript, functions act as “closures”. The term closure refers to a function which retains references to the scope in which it was defined. By using dynamically generated closures it is possible to create access functions which fully encapsulate the instance data themselves. This technique is clearly documented for the Perl language in the book Object-Oriented Perl by Damian Conway. The approach defined there could be adapted to ECMAScript with little change.

The add*Property functions could be altered to comprise a single function taking appropriate parameters rather than a set of functions arranged by the target type (Global, Local, Type, Inst). The use of separate functions in the preferred embodiment provides a measure of documentation and clarity but is not required for proper operation.

The location and structure of the specific reflection data structures may vary based on the specific requirements addressed. In the preferred embodiment reflection information on the various properties added to a type for use by the type or instances of the type are stored in dictionaries along with other type reflection data.

The order of operations in the property-definition functions can be altered with little impact on the final result. The specific parameter values regarding visibility, mutability, and storage can be altered as well although the use of private, public, protected, and final are industry standards.

There are a multitude of various control methods which could be generated and nested to create powerful operational control over the execution of a program using the invention.

Polymorphism

To integrate cleanly with the native ECMAScript lookup machinery there must be some form of backstop method put in place. Future enhancements to ECMAScript may offer a native fashion to hook methods which are not found. The use of this hook would not reduce the value of responding to that invocation by inferring a new method based on type conversion rules.

The specific implementation details of the backstop function itself can vary widely, as can the mechanisms defined for determining which type conversions to attempt and which to avoid. As the previous discussions mention, the preferred embodiment here is to plan for this by utilizing a Strategy pattern. The preferred embodiment prefers to rely on the native ECMAScript method lookup and dispatch mechanism for performance.

How the available type conversions and methods are registered can also be altered. The preferred embodiment leverages the type definition process itself, through the use of the add*Method calls, to capture this information. A more explicit set of functions could be used to perform these registrations, perhaps avoiding the use of such method-definition functions as it relates to this process.

Reflection

Reflection can be performed at runtime with proper information available. The current implementation uses “track” and “owner” information to assist with runtime reconstruction of reflection data. This can also be performed by capturing data via encapsulation access methods such as those defined earlier using the patterns add*, get* and has*.

### CONCLUSION, RAMIFICATIONS, AND SCOPE

Inheritance

The invention repairs a serious flaw in the current ECMAScript type inheritance model allowing ECMAScript to fulfill the fundamental guarantee of object-oriented programming; namely that instances of subtypes should function effectively and without error as instances of their supertypes.

The ramifications of this repair are significant. ECMAScript is perhaps the most ubiquitous scripting language of all time, existing in virtually every web browser; every modern copy of the Microsoft Windows operating system as part of the Windows Scripting Host; and numerous other widely used applications including Lotus Notes, Adobe GoLive, Macromedia Dreamweaver, etc. As such, proper object-oriented semantics in the ECMAScript language have far-reaching implications. The invention provides this much-needed support without requiring alteration to existing ECMAScript interpreters or the addition of plug-ins or other new technology.

The additional advantages of the invention including leveraging the existing ECMAScript lookup mechanisms for performance and memory optimization; retaining the power of instance-specific programming for types; method and state overriding and reuse in subtypes; multiple-inheritance; dynamic instance optimization; and the other advantages previously enumerated cannot be underestimated with respect to their impact on ECMAScript and web programming.

Encapsulation

The invention further provides support for a critical object-oriented language facility with respect to ECMAScript; namely encapsulation of state and behavior and proper reflection upon said state and behavior.

The ability to constrain property access and support encapsulation of objects is a critical feature of object-oriented languages. By constraining properties when they are defined, robust programs can check to ensure whether type constraints or other controls are being adhered to. This functionality is critical to the creation of robust, bug-free software. By supporting a mechanism which enables encapsulation of properties to occur the invention adds significant value to the ECMAScript programming environment.

An additional advantage, which has significant performance implications, is the ability to manage state separately from the individual instances which are being manipulated. Using separate data structures for instance storage allows all instance data in the system to be searched, sorted, or in other ways manipulated. This functionality is a significant benefit for applications which require high performance and/or client-side data manipulation capability.

Polymorphism

The invention solves a serious problem with type-safety in JavaScript by offering a dynamic mechanism for trapping errors from unimplemented methods and potentially resolving them via automatic type conversion and method generation. This approach has further benefits in reducing code size for applications which must travel over the Internet to reach a target browser since many methods can be inferred and generated from within the client. It also has the effect of reducing the time required for development. Developers can construct a set of base types and type conversion methods and allow the inferencing behavior begin to fill in aspects of their application for them. The result is a system that has fewer errors and takes less time to develop and deploy.

Reflection

A feature strongly required for proper inheritance support is reflection. The invention takes advantage of a set of encapsulation methods for adding attributes, methods, and constants to types, instances, and global namespaces to capture reflection data. The result is a system which can accurately reflect on types and instances, thereby supporting proper method overriding semantics, protocols or interfaces, as well as Java Bean programming patterns which have become more prevalent in recent years.

We hereby claim:

1. A method for implementing type inheritance and instance inheritance in JavaScript, comprising the steps of:
creating a first Function instance (F1);
creating a second Function instance (F2);
creating a type object (T) from F1;
assigning F1 as T's type constructor or T's subtype prototype constructor; and
assigning F2 as T's instance constructor or T's subtype instance prototype constructor.

2. The method of claim 1, further comprising the steps of:
creating a third Function instance (F3);
creating a fourth Function instance (F4);
creating an F3.prototype from F1;
creating an F4.prototype from F2;
creating a subtype object (S) from F3;
assigning F3 as S's type constructor or S's subtype prototype constructor; and
assigning F4 as S's instance constructor or S's subtype instance prototype constructor.

3. The method of claim 2, wherein, S is a subtype of T, forming a hierarchy tree (H).

4. The method of claim 3, wherein, H further comprises a plurality of types and a plurality of subtypes.

5. The method of claim 1, further comprising the steps of:
employing “new” keyword with F1 and creating a subtype; and
employing “new” keyword with F2 and creating an instance (I).

6. The method of claim 2, further comprising the steps of:
employing “new” keyword with F3 and creating a subtype; and
employing “new” keyword with F4 and creating an instance (I).

7. The method of claim 2, further comprising the step of:
invoking a F1 or F3 to maintain type hierarchy data.

8. The method of claim 2, further comprising the steps of:
creating an instance of S or T (I); and
assigning a unique identifier (UID) to I.

9. The method of claim 5, further comprising the step of:
storing I in a set.

10. The method of claim 8, further comprising the step of:
storing I and UID in a set.

11. The method of claim 1, further comprising the step of:
copying at least one property from an object to an F1.prototype.

12. The method of claim 1, further comprising the step of:
copying at least one property from an object to an F2.prototype.

13. The method of claim 2, further comprising the step of:
copying at least one property from an object to the F3.prototype.

14. The method of claim 2, further comprising the step of:
copying at least one property from an object to the F4.prototype.

15. The method of claim 3, further comprising the steps of:
creating a lookup Function instance (LF), wherein LF is adapted to search type hierarchy metadata or H to locate an inherited method (IM) for an object (O) by method name (N); and
invoking LF with O and N or a function instance associated with N, returning IM.

16. The method of claim 15, wherein the invoking LF step invokes LF as a method of O with N or a function instance associated with N, returning IM.

17. The method of claim 15, further comprising the step of:
invoking IM as a method of O.

18. The method of claim 15, further comprising the step of:
creating a reference (R) to IM wherein the length of a lookup chain from O to R is shorter than the length of a method lookup path from O to IM.

19. A method for defining an object method in JavaScript, comprising the steps of:
creating a conversion Function instance (CF), wherein CF is adapted to operate on a Function instance (F), CF further adapted to create a control method (M) which invokes F as part of its operation;
invoking CF; and
substituting M for F.

20. A method for creating bound functions in JavaScript, comprising the steps of:
creating a binding Function instance (BF), wherein BF is adapted to create a new bound Function instance (B) by creating a closure which invokes a Function instance (F) as a method of an object;
invoking BF; and
substituting B for F.

21. A method for handing unresolved methods in JavaScript, comprising the steps of:
creating a backstop Function instance (BF), BF adapted to capture an argument list when invoked; and
acquiring one or more method names (N) implemented by at least one object; and
assigning BF to an object prototype having no implementation of N.

22. A method for delegating functionality in JavaScript, comprising the steps of:
associating a first object with a second object, the first object being a delegate for the second object;
creating a Function instance (F), wherein F is adapted to find a missing property on the second object by searching delegates for the missing property; and
invoking F from an onerror handler or a catchall function.

23. A method for inferring operations in an Object-Oriented language, comprising the steps of:
identifying a method (M) incompatible with a first type (T1), a first object (O1) being an instance of T1;
identifying a second type (T2) compatible with M;
identifying an algorithm (A) capable of converting O1 into second object (O2) being an instance of T2;
employing A to convert O1 to O2; and
executing M as a method of O2.

24. The method of claim 23, further comprising the step of:
creating a Function instance (NF), wherein NF is adapted to employ A to convert an third object of type T1 into a fourth object of type T2 and execute M as a method of the fourth object.

25. The method of claim 24, further comprising the step of substituting NF for M.

26. The method of claim 25, further comprising the steps of:
saving instructions for NF to persistent storage; and
saving instructions for substituting NF for M to persistent storage.
